(19) United States
(12) Patent Application Publication
(10) Pub. No.: US 2025/0014279 A1
(43) Pub. Date: Jan. 9, 2025

(54) MATCHING A BUILDING INFORMATION MODEL

(71) Applicant: XYZ REALITY LIMITED, London (GB)

(72) Inventors: Umar AHMED, London (GB); Kazimali KHAKI, London (GB); David MITCHELL, London (GB)

(73) Assignee: XYZ REALITY LIMITED, London (GB)

(21) Appl. No.: 18/712,390

(22) PCT Filed: Nov. 18, 2022
(86) PCT No.: PCT/EP2022/082394

§ 371 Date: May 22, 2024

(30) Foreign Application Priority Data
Nov. 24, 2021 (GB) 2116925.5

(51) Int. Cl. G06T 17/20; G06F 3/01; G06Q 50/08

(52) U.S. Cl. CPC G06T 17/20; G06F 3/012; G06Q 50/08

(57) ABSTRACT

In described examples there is a method of matching a design model. In examples, a point cloud representation of a construction site is generated. The point cloud representation is generated using a positioning system that tracks a device such as a headset within the construction site. A building information model is obtained representing at least a portion of the construction site. One or more points in the point cloud representation are compared with the building information model to determine whether the construction site matches the building information model, wherein the point cloud representation is generated dynamically as the device navigates the construction site.

### TECHNICAL BACKGROUND

The present invention relates to a method of matching a building information model, a three-dimensional model used for construction, e.g. against a measured set of points at a site to be constructed according to the model. Certain preferred embodiments of the present invention relate to building a map of a construction site using a mapping device and then comparing this map with the building information model to determine deviations from, and/or updates to, the model.

### BACKGROUND OF THE INVENTION

Erecting a structure or constructing a building on a construction site is a lengthy process. The process can be summarised as follows. First, a three-dimensional (3D) model, known as a Building Information Model (BIM), is produced by a designer or architect. The BIM model is typically defined in real world coordinates. The BIM model is then sent to a construction site, most commonly in the form of two-dimensional (2D) drawings or, in some cases, as a 3D model on a computing device. An engineer, using a conventional stake out/set out device, establishes control points at known locations in the real-world coordinates on the site and uses the control points as a reference to mark out the location where each structure in the 2D drawings or BIM model is to be constructed. A builder then uses the drawings and/or BIM model in conjunction with the marks (“Set Out marks”) made by the engineer to erect the structure according to the drawings or model in the correct place. Finally, an engineer must validate the structure or task carried out. This can be performed using a 3D laser scanner to capture a point-cloud from which a 3D model of the “as built” structure can be derived automatically. The “as built” model is then manually compared to the original BIM model. This process can take up to two weeks, after which any items that are found to be out of tolerance must be reviewed and may give rise to a penalty or must be re-done.

The above method of erecting a structure or constructing a building on a construction site has a number of problems. Each task to be carried out at a construction site must be accurately set out in this way. Typically, setting out must be done several times during a project as successive phases of the work may erase temporary markers. Further, once a task has been completed at a construction site, it is generally necessary to validate the task or check it has been done at the correct location. Often the crew at a construction site need to correctly interpret and work from a set of 2D drawings created from the BIM. This can lead to discrepancies between the built structure and the original design. Also set control points are often defined in relation to each other, meaning that errors chaotically cascade throughout the construction site. Often these negative effects interact over multiple layers of contractors, resulting in projects that are neither on time, within budget nor to the correct specification.

WO2019/048866 A1 (also published as EP3679321), which is incorporated by reference herein, describes a headset for use in displaying a virtual image of a BIM in relation to a site coordinate system of a construction site. In one example, the headset comprises an article of headwear having one or more position-tracking sensors mounted thereon, augmented reality glasses incorporating at least one display, a display position tracking device for tracking movement of the display relative to at least one of the user's eyes and an electronic control system. The electronic control system is configured to convert a BIM defined in an extrinsic, real world coordinate system into an intrinsic coordinate system defined by a position tracking system, receive display position data from the display position device and headset tracking data from a headset tracking system and render a virtual image of the BIM relative to the position and orientation of the article of headwear on the construction site and relative position of the display relative to the user's eye and transmit the rendered virtual image to the display which is viewable by the user.

US 2016/292918 A1, incorporated by reference herein, describes a method and system for projecting a model at a construction site using a network-coupled hard hat. Cameras are connected to the hard hat and capture an image of a set of registration markers. A position of the user device is determined from the image and an orientation is determined from motion sensors. A BIM is downloaded and projected to a removable visor based on the position and orientation.

WO2019/048866 A1 and US 2016/292918 A1 teach different incompatible methods for displaying a BIM at a construction site. Typically, a user needs to choose a suitable one of these described systems for any implementation at a construction site. The systems and methods of WO2019/048866 A1 provide high accuracy continuous tracking of the headset at a construction site for display of the BIM. However, even high accuracy position tracking systems still have inherently noisy measurements that make maintaining high accuracy difficult. Calibration of the “lighthouse” beacon system of WO2019/048866 A1 further requires the combination of the headset and the calibration tool.

As described above, it is desired to compare a BIM with actual objects and surfaces within a construction site to determine whether something is built correctly or not. For example, often constructed items vary from a design model (i.e., BIM), either because the original model was not designed correctly, or the construction was wrong. A BIM is generally updated by a sub-contractor working on a construction site. Information is often provided to a design team processing the BIM in the form of a survey data. A survey method could include any of the following: red line drawings, a measured set of survey points, a file (such as a comma-separated file) containing (measured) coordinate points (e.g., with pictures of the construction site), or a Computer-Aided Design (CAD) drawing. These methods of comparing and updating a BIM are often time-consuming and onerous. For example, it often takes hours, if not days, to compare measured points (e.g., control points measured using survey equipment such as a total station or theodolite) with the BIM, even if this process is substantially automated. Furthermore, this process is resource intensive and computational hard. The results of any automated comparison are also often not useable by engineers on site. For example, dense point cloud comparisons often result in thousands of variations or deviations from a BIM, each of which need to be reviewed manually. For these reasons and others, many engineers and architects often just to result to comparing points and models by eye, an approach which often leads to further errors and mismatches.

US2019/347783 A1 describes a computer aided inspection system. A first sensor package acquires data to perform global localization. The first sensor package may be a helmet worn compact sensor package comprising wide field of view cameras, IMUs, barometers, altimeters, magnetometers, GPS, etc. Global localization locates a user within a first level of accuracy, e.g. 5-15 cm. A second sensor package is then used to perform fine measurements, e.g. at millimetre accuracy. The second sensor package is described as forming part of a handheld device such as a tablet that may comprise higher resolution sensors.

The computer aided inspection system of US2019/347783 A1 faces a problem of complexity and practical implementation. For example, two parallel systems need to be coordinated and each system has its own independent sources of noise and variation. The process of aligning the first and second measurements requires a complex handshake procedure and requires a user to press a button on the tablet or helmet before recording a number of second sensor measurements. Also, the second sensor package only measures a small local area, making inspection of large building sites onerous.

DE102019105015 A1 relates to computer-implemented support in the construction and control of formworks and scaffolds on construction sites. A mobile device is used to explore a construction site and a transformation is computed between the mobile device internal coordinate system and an absolute coordinate system of the construction site. A direct visual comparison of the physical scenery at the construction site and any plans then may be used to identify plan deviations and errors during the assembly of the formwork.

CN214230073 U describes a “BIM-based safety helmet” that has a VR camera device and an infrared distance measurement device attached to a universal wheel. The VR camera device is used to obtain three-dimensional data of a building component and the infrared distance measurement device is used to obtain distance data of the user from the building component. The three-dimensional data from the VR camera device may be used for a position comparison with a BIM three-dimensional model. The infrared distance measurement device is used to detect whether the user is at an improper distance for the capture of three-dimensional data using the VR camera device and may be used to move the user to a better position for the VR camera device.

The paper “Applications of 3D point cloud data in the construction industry: A fifteen-year review from 2004 to 2018”, by Wang Qian et al, as published in Advanced Engineering Informatics, vol 39, 2019 (pages 306-319) describes how there are still research gaps when attempting to use 3D point cloud data in the construction industry. There are the dual problems of acquiring point cloud data and the need for high accuracy. The paper points out that research is still lacking for real-time visualisation and processing of point cloud data for construction applications.

There is thus a specific challenge of providing easy-to-use methods for the checking and updating of building information models so as to reduce the cost and time of construction projects.

### SUMMARY OF THE INVENTION

Aspects of the present invention are set out in the appended independent claims. Variations of these aspects are set out in the appended dependent claims. Examples that are not claimed are also set out in the description below.

### BRIEF DESCRIPTION OF THE DRAWINGS

Examples of the invention will now be described, by way of example only, with reference to the accompanying drawings, in which:

FIG. 1A is a schematic illustration of one example positioning system in use at a construction site.

FIG. 1B is a schematic illustration showing how BIM data may be aligned with a view of the construction site.

FIG. 2A is schematic illustration showing, in perspective and from one side, an example hard hat incorporating an augmented reality display.

FIG. 2B is schematic illustration showing electronic components implementing a tracking module and an augmented reality display module for the hard hat of FIG. 2A.

FIGS. 3A and 3B are schematic illustrations showing different arrangements of 2D markers at a construction site that may be used for calibration according to one example.

FIG. 4 is a flow chart showing a method for comparing a building information model (BIM) with measured points at a construction site according to an example.

FIG. 5 is a schematic illustration showing an example of an adapted hard hat with an attached laser scanning device.

FIG. 6 is a schematic illustration showing an example of an adapted hard hat with an attached wide-field-of-view camera device.

FIG. 7 is a schematic illustration showing example coordinate systems for the representation of points and the mapping between those coordinate systems.

FIG. 8 is a schematic illustration showing how a surface or mesh may be fitted to a set of measured points.

### DETAILED DESCRIPTION

Certain examples described herein relate to comparing measured data from a construction site with a building information model (BIM). This comparison may form the basis of an update of the BIM and/or an output that documents one or more deviations of the actual built site from the BIM. Certain examples described herein focus on generating a point cloud representation of the construction site and using this to compare with the BIM. Point cloud representations are advantageous as they are accurate and time-efficient.

Certain examples described herein relate to registration of a measured point cloud with points from a model such as a BIM. Registration as described herein relates to aligning points in two or more sets of points. In certain examples described herein, registration is performed as a two-stage process. A headset for displaying virtual images of the BIM is adapted such that the pose of the headset, as measured by a positioning system to allow alignment with the BIM, may be used to relate point measurements made from the headset with the BIM. Registration in general may be performed using detected overlap in two point clouds (e.g. where the overlap is used to align), and/or using three or more targets with known positions that are available in both point clouds (e.g., to derive a transformation that maps between the two sets of points). In other examples, a measured point cloud may be aligned with the BIM by using the overlap and/or known point comparisons. In these other examples, if there is no overlap between two point clouds, then the two clouds may be georeferenced (e.g., a known point in geographical space may be measured and identified in both point clouds) and/or aligned manually, e.g. by equating known visible points like corners.

In examples described herein, when comparing a point cloud and a BIM, surfaces and objects within the BIM may be converted into a set of points and/or points within the point cloud may be converted into surfaces and objects. For example, clustering, segmentations, and/or classification may be performed on points in a point cloud to determine groups of points that relate to surfaces and/or objects, or surfaces and/or objects that are derived from the points of the point cloud (e.g., via “best fit” optimisations that seek to fit planes and other geometric structures).

Once two sets of points (i.e., two point clouds-one measured, one derived from the BIM) have been registered, the two sets of points may be compared to determine differences between the sets of points. For example, a measured set of points, e.g. from a laser scanner, may be compared with an original 3D design model (e.g., a BIM). Comparative solutions, such as Verity™ from ClearEdge3D Inc. of Superior, Colorado, allow an engineer to manually specify a tolerance and locate points that are within that tolerance, e.g. setting a distance X=2 cm and finding anything in the point cloud that matches the model within that specified (X) distance. However, these comparative solutions apply little intelligence in the comparison, e.g. objects are not recognised such that a pipe may be said to be 2 cm from a wall rather than different portions of the wall. Further, existing solutions cannot recognise similar surfaces of different dimensions. With these comparative solutions, if the point cloud is not dense enough, there are often problems. For example, it may be difficult to create continuous surfaces and therefore, say, tell the different between a pipe and a wall. The result of these comparative solutions is often provided as a long list of suggestions to update the model, where a user reviews and confirms each update (e.g., by clicking “yes” to update for each deviation).

Comparative solutions for comparing measured points and a BIM have been found to be slow. For example, for a single room, available comparative solutions often take between 4-9 hours to import a BIM and provide suggestions, where on average a user is provided with 5000 suggestions per room. The comparative solutions also need a powerful computing device to input and analyse the dense point clouds that are required for the analysis. If the comparative solution, fails to recognise a single object or item (e.g., a pipe or a wall) and provide this as one suggestion, it provides a large collection of elements and suggestions. These are difficult to review and process. Even if engineers or architects review the multitude of suggestions, it has been found that they are often not used in practice, and instead the engineer or architect updates the BIM manually, taking several minutes per suggestion. For a typical 5000 suggestions, this process can take many weeks. This is one reason why comparative solutions are not widely used by professionals. Instead, professionals often load the original BIM model, import a measured and georeferenced point cloud as an overlay, and then manually confirm elements by eye.

### Introduction

Certain examples described herein use a measured map of a construction site (e.g., a measured point map) that is generated by a mapping system to analyse a model of the same site, such as a BIM, and determine whether the map matches the model. Where there are differences, these may be presented to a user and/or used to update the BIM. In certain examples, a map may be generated using points that are generated using a device such as a headset that navigates the construction site, where the device is initially calibrated using a positioning system. The map, which may comprise a point cloud, is generated based on measurements relative to the device (e.g., relative to one or more sensors coupled to the device). As the position of the device is accurately tracked by way of the calibrated positioning system, point measurements made from sensors coupled to the device may also be accurately located, e.g. assigned coordinates in a coordinate system that is matched or transformed to the coordinate system of the BIM. In this manner, the map may comprise an accurate representation of the environment (e.g., accuracy of less than 1 mm) that is referenced or registered to points in a BIM by way of the positioning system. A device may be calibrated using a marker as described later and/or via the calibration methods described in WO2019/048866 A1. Once the positioning system is calibrated, then as the device moves around the construction site, e.g. as worn by a user, a set of points is measured automatically, e.g. either as part of a map generated by a mapping system or via a survey instrument coupled to the device. As the device is calibrated, the points are all referenced to the calibration. The calibration further provides a link or transformation that aligns the BIM, e.g. one or more calibrated points have known locations on the construction site (e.g., georeferenced or measured using a control marker) and known corresponding locations within the BIM (e.g., a particular set of geographic coordinates). This means that subsequent measured points that are not calibrated points are accurately positioned with respect to the calibrated points, and can thus be instantly compared with the BIM without lengthy analysis. It also means that points that are deemed to match the BIM (e.g., are in the “right” location with respect to a design and a set of geographic coordinates) may be fixed and used as calibration references for further measured points, e.g. future mapping.

In certain examples, as a device is navigated around a construction site, e.g. as a user with a headset walks around, a BIM comparison may be performed in real-time. With this BIM comparison, measured points in the real construction site that match points within the BIM (e.g., within a defined small tolerance such as millimetres or less) may be “signed off”, e.g. approved or confirmed, and measured points in the real construction site that do not match points within the BIM points (e.g., within a defined tolerance) may be flagged, presented for review, and/or used to automatically update the BIM. The present examples leverage the accurate positioning of a headset, which is used for viewing a virtual image of the BIM on a head-mounted display, to also accurately map point cloud measurements performed from the headset.

The present examples provide a benefit over comparative methods of point measurement. For example, in comparative examples a point cloud may be generated by a stationary laser scanner. The laser scanner is placed in a known (e.g., geopositioned) location. The location may be marked and/or configured using survey equipment such as a total station or theodolite. The laser scanner then acquires one or more point measurements, e.g. using a static or rotating laser device where a laser beam is emitted from the laser scanner and reflected from objects in the surroundings, and where phase differences between emitted and received beams may be used to accurately measure (ray) distances. However, these laser scanners need to be correctly located for each scan. Typically, the laser scanner needs to be at a geopositioned location and within view of a control marker (e.g., a distinguishable point that has a known surveyed location). If the laser scanner is positioned incorrectly or is not in view of a control point, the point cloud data cannot be referenced to the BIM. Furthermore, because laser scanners require line-of-sight (i.e., a straight line to a measured surface point), they typically need to be set up in multiple locations within rooms with corners and other artifacts (e.g., rooms where measurement of all desired surfaces cannot be made from any one point). This means for more complex building designs, multiple control markers and multiple laser scanner measurements are required, even for 360-degree scanning devices. These devices also generate dense point clouds with thousands or millions of points. These are difficult to compare with models and are onerous to review.

Examples described herein do not dependent on constant visibility of a control marker, or of accurate positioning for every point measurement. Instead, a control marker or other approach may be used to calibrate a device infrequently, and a mapping system used to measure points that are referenced to calibrated points. For example, a user may start in a room, view a control marker to initiate calibration of a tracked headset, and then walk around to view another side of a wall or object that does not have a control marker and that is out of the line of sight of the initial starting position. However, when the user views this other side, the wall or object is mapped (e.g., either as a dense or sparse point cloud) and the map is still in sync with the BIM via the calibration. Alternatively, a handheld sensor may be located at certain control points with a known geographic (e.g., georeferenced) coordinate (e.g., in three dimensions) within a room being constructed to initially calibrate the positioning system, and then the positioning system may then track a headset of the user in the same way as they navigate around the room, regardless of the shape complexity of the room or the objects within it.

### Certain Term Definitions

Where applicable, terms used herein are to be defined as per the art. To ease interpretation of the following examples, explanations and definitions of certain specific terms are provided below.

The term “positioning system” is used to refer to a system of components for determining one or more of a location and orientation of an object within an environment. The terms “positional tracking system” and “tracking system” may be considered alternative terms to refer to a “positioning system”, where the term “tracking” refers to the repeated or iterative determining of one or more of location and orientation over time. A positioning system may be implemented using a single set of electronic components that are positioned upon an object to be tracked, e.g. a stand-alone system installed in a device such as a headset. In other cases, a single set of electronic components may be used that are positioned externally to the object. In certain cases, a positioning system may comprise a distributed system where a first set of electronic components is positioned upon an object to be tracked and a second set of electronic components is positioned externally to the object. These electronic components may comprise sensors and/or processing resources (such as cloud computing resources). A positioning system may comprise processing resources that may be implemented using one or more of an embedded processing device (e.g., upon or within the object) and an external processing device (e.g., a server computing device). Reference to data being received, processed and/or output by the positioning system may comprise a reference to data being received, processed and/or output by one or more components of the positioning system, which may not comprise all the components of the positioning system.

The term “pose” is used herein to refer to a location and orientation of an object. For example, a pose may comprise a coordinate specifying a location with reference to a coordinate system and a set of angles representing orientation of a point or plane associated with the object within the coordinate system. The point or plane may, for example, be aligned with a defined face of the object or a particular location on the object. In certain cases, an orientation may be specified as a normal vector or a set of angles with respect to defined orthogonal axes. In other cases, a pose may be defined by a plurality of coordinates specifying a respective plurality of locations with reference to the coordinate system, thus allowing an orientation of a rigid body encompassing the points to be determined. For a rigid object, the location may be defined with respect to a particular point on the object. A pose may specify the location and orientation of an object with regard to one or more degrees of freedom within the coordinate system. For example, an object may comprise a rigid body with three or six degrees of freedom. Three degrees of freedom may be defined in relation to translation with respect to each axis in 3D space, whereas six degrees of freedom may add a rotational component with respect to each axis. In other cases, three degrees of freedom may represent two orthogonal coordinates within a plane and an angle of rotation (e.g., [x, y, θ]). Six degrees of freedom may be defined by an [x, y, z, roll, pitch, yaw] vector, where the variables x, y, z represent a coordinate in a 3D coordinate system and the rotations are defined using a right hand convention with respect to three axes, which may be the x, y and z axes. In examples herein relating to a headset, the pose may comprise the location and orientation of a defined point on the headset, or on an article of headwear that forms part of the headset, such as a centre point within the headwear calibrated based on the sensor positioning on the headwear.

The term “coordinate system” is used herein to refer to a frame of reference, e.g. as used by one or more of a positioning system, a mapping system, and a BIM. Different devices, systems and models may use different coordinate systems. For example, a pose of an object may be defined within three-dimensional geometric space, where the three dimensions have corresponding orthogonal axes (typically x, y, z) within the geometric space. An origin may be defined for the coordinate system where lines defining the axes meet (typically, set as a zero point—(0, 0, 0)). Locations for a coordinate system may be defined as points within the geometric space that are referenced to unit measurements along each axis, e.g. values for x, y, and z representing a distance along each axis. In certain cases, quaternions may be used to represent at least an orientation, of an object such as a headset or camera within a coordinate system. In certain cases, dual quaternions allow positions and rotations to be represented. A dual quaternion may have 8 dimensions (i.e., comprise an array with 8 elements), while a normal quaternion may have 4 dimensions.

The terms “intrinsic” and “extrinsic” are used in certain examples to refer respectively to coordinate systems within a positioning system and coordinate systems outside of any one positioning system. For example, an extrinsic coordinate system may be a 3D coordinate system for the definition of an information model, such as a BIM, that is not associated directly with any one positioning system, whereas an intrinsic coordinate system may be a separate system for defining points and geometric structures relative to sensor devices for a particular positioning system.

Certain examples described herein use one or more transformations to convert between coordinate systems. The term “transformation” is used to refer to a mathematical operation that may be performed on one or points (or other geometric structures) within a first coordinate system to map those points to corresponding locations within a second coordinate system. For example, a transformation may map an origin defined in the first coordinate system to a point that is not the origin in the second coordinate system. A transformation may be performed using a matrix multiplication. In certain examples, a transformation may be defined as a multi-dimensional array (e.g., matrix) having rotation and translation terms. For example, a transformation may be defined as a 4 by 4 (element) matrix that represents the relative rotation and translation between the origins of two coordinate systems. The terms “map”, “convert” and “transform” are used interchangeably to refer to the use of a transformation to determine, with respect to a second coordinate system, the location and orientation of objects originally defined in a first coordinate system. It may also be noted that an inverse of the transformation matrix may be defined that maps from the second coordinate system to the first coordinate system.

Certain examples described herein are directed towards a “headset”. The term “headset” is used to refer to a device suitable for use with a human head, e.g. mounted upon or in relation to the head. The term has a similar definition to its use in relation to so-called virtual or augmented reality headsets. In certain examples, a headset may also comprise an article of headwear, such as a hard hat, although the headset may be supplied as a kit of separable components. These separable components may be removable and may be selectively fitted together for use, yet removed for repair, replacement and/or non-use. Although the term “augmented reality” is used herein, it should be noted that this is deemed to be inclusive of so-called “virtual reality” approaches, e.g. includes all approaches regardless of a level of transparency of an external view of the world. Examples described with reference to a headset may also be extended, in certain cases, to any device, e.g. a device that is wearable or carry-able by a user as they navigate a construction site.

Certain positioning systems described herein use one or more sensor devices to track an object such as a headset. Sensor devices may include, amongst others, monocular cameras, stereo cameras, colour cameras, greyscale cameras, depth cameras, active markers, passive markers, photodiodes for detection of electromagnetic radiation, radio frequency identifiers, radio receivers, radio transmitters, and light transmitters including laser transmitters. A positioning system may comprise one or more sensor devices upon an object. Certain, but not all, positioning systems may comprise external sensor devices such as tracking devices. For example, an optical positioning system to track an object with active or passive markers within a tracked volume may comprise externally mounted greyscale camera plus one or more active or passive markers on the object.

Certain examples described herein use mapping systems. A mapping system is any system that is capable of constructing a three-dimensional map of an environment based on sensor data. In certain cases, a positioning system and a mapping system may be combined, e.g. in the form of a simultaneous localisation and mapping (SLAM) system. In other cases, the positioning system may be independent of the mapping system. In described examples, the mapping system comprises a set of sensor devices, such as a camera and/or laser scanning device. The mapping system uses a coordinate system to define measured points within the map. This coordinate system is typically referenced to the set of sensors that are measuring point locations.

Certain examples provide a device for use on a construction site. The term “construction site” is to be interpreted broadly and is intended to refer to any geographic location where objects are built or constructed. A “construction site” is a specific form of an “environment”, a real-world location where objects reside. Environments (including construction sites) may be both external (outside) and internal (inside). Environments (including construction sites) need not be continuous but may also comprise a plurality of discrete sites, where an object may move between sites. Environments include terrestrial and non-terrestrial environments (e.g., on sea, in the air or in space).

The term “render” has a conventional meaning in the image processing and augmented reality arts and is used herein to refer to the preparation of image data to allow for display to a user. In the present examples, image data may be rendered on a head-mounted display for viewing. The term “virtual image” is used in an augmented reality context to refer to an image that may be overlaid over a view of the real-world, e.g. may be displayed on a transparent or semi-transparent display when viewing a real-world object. In certain examples, a virtual image may comprise an image relating to an “information model”. The term “information model” is used to refer to data that is defined with respect to an extrinsic coordinate system, such as information regarding the relative positioning and orientation of points and other geometric structures on one or more objects. In examples described herein the data from the information model is mapped to known points within the real-world as tracked using one or more positioning systems, such that the data from the information model may be appropriate prepared for display with reference to the tracked real-world. For example, general information relating to the configuration of an object, and/or the relative positioning of one object with relation to other objects, that is defined in a generic 3D coordinate system may be mapped to a view of the real-world and one or more points in that view.

The terms “engine” and “control system” is used herein to refer to either hardware structure that has a specific function (e.g., in the form of mapping input data to output data) or a combination of general hardware and specific software (e.g., specific computer program code that is executed on one or more general purpose processors). An “engine” or a “control system” as described herein may be implemented as a specific packaged chipset, for example, an Application Specific Integrated Circuit (ASIC) or a programmed Field Programmable Gate Array (FPGA), and/or as a software object, class, class instance, script, code portion or the like, as executed in use by a processor.

The term “camera” is used broadly to cover any camera device with one or more channels that is configured to capture one or more images. In this context, a video camera may comprise a camera that outputs a series of images as image data over time, such as a series of frames that constitute a “video” signal. It should be noted that any still camera may also be used to implement a video camera function if it is capable of outputting successive images over time. Reference to a camera may include a reference to any light-based sensing technology including event cameras and LIDAR sensors (i.e. laser-based distance sensors). An event camera is known in the art as an imaging sensor that responds to local changes in brightness, wherein pixels may asynchronously report changes in brightness as they occur, mimicking more human-like vision properties.

The term “image” is used to refer to any array structure comprising data derived from a camera. An image typically comprises a two-dimensional array structure where each element in the array represents an intensity or amplitude in a particular sensor channel. Images may be greyscale or colour. In the latter case, the two-dimensional array may have multiple (e.g., three) colour channels. Greyscale images may be preferred for processing due to their lower dimensionality. For example, the images processed in the later described methods may comprise a luma channel of a YUV video camera.

The term “two-dimensional” or “2D” marker is used herein to describe a marker that may be placed within an environment. The marker may then be observed and captured within an image of the environment. The 2D marker may be considered as a form of fiducial or registration marker. The marker is two-dimensional in that the marker varies in two dimensions and so allows location information to be determined from an image containing an observation of the marker in two dimensions. For example, a 1D marker barcode only enables localisation of the barcode in one dimension, whereas a 2D marker or barcode enables localisation within two dimensions. In one case, the marker is two-dimensional in that corners may be located within the two dimensions of the image. The marker may be primarily designed for camera calibration rather than information carrying, however, in certain cases the marker may be used to encode data. For example, the marker may encode 4-12 bits of information that allows robust detection and localisation within an image. The markers may comprise any known form of 2D marker including AprilTags as developed by the Autonomy, Perception, Robotics, Interfaces, and Learning (APRIL) Robotics Laboratory at the University of Michigan, e.g. as described in the paper “AprilTag 2: Efficient and robust fiducial detection” by John Wang and Edwin Olson (published at the Proceedings of the IEEE/RSJ International Conference on Intelligent Robots and Systems October 2016) or ArUco markers as described by S. Garrido-Jurado et al in the 2014 paper “Automatic generation and detection of highly reliable fiducial markers under occlusion”, (published in Pattern Recognition 47, 6, June 2014), both of which are incorporated by reference herein. Although the markers shown in the Figures are block or matrix based, other forms with curved or non-linear aspects may also be used (such as RUNE-Tags or reacTIVision tags). Markers also need not be square or rectangular, and may have angled sides. As well as specific markers for use in robotics, common Quick Response—QR-codes may also be used. The 2D markers described in examples herein may be printed onto a suitable print medium and/or display on one or more screen technologies (including Liquid Crystal Displays and electrophoretic displays). Although two-tone black and white markers are preferred for robust detection with greyscale images, the markers may be any colour configured for easy detection. In one case, the 2D markers may be cheap disposable stickers for affixing to surfaces within the construction site.

The term “control marker”, “set-out marker” or “survey marker” is used to refer to markers or targets that are used in surveying, such as ground-based surveying. Typically, these markers or targets comprise a reflective and/or clearly patterned surface to allow accurate measurements from an optical instrument such as a total station or theodolite. These markers or targets may comprise existing markers or targets as used in the art of surveying. These markers or targets may simply comprise patterned reflective stickers that may be affixed to surfaces within a construction site.

### Example of Tracking on a Construction Site

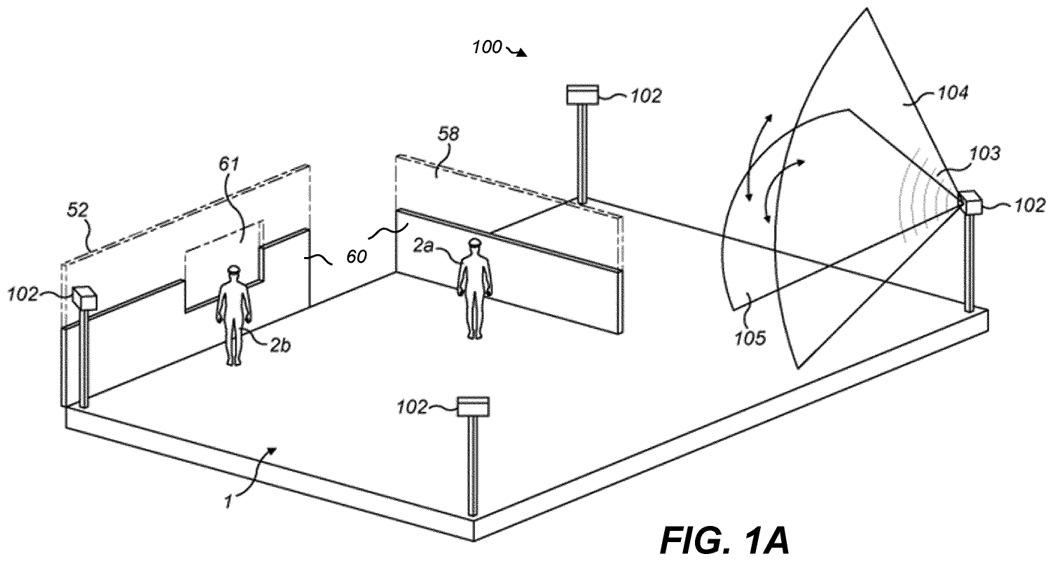

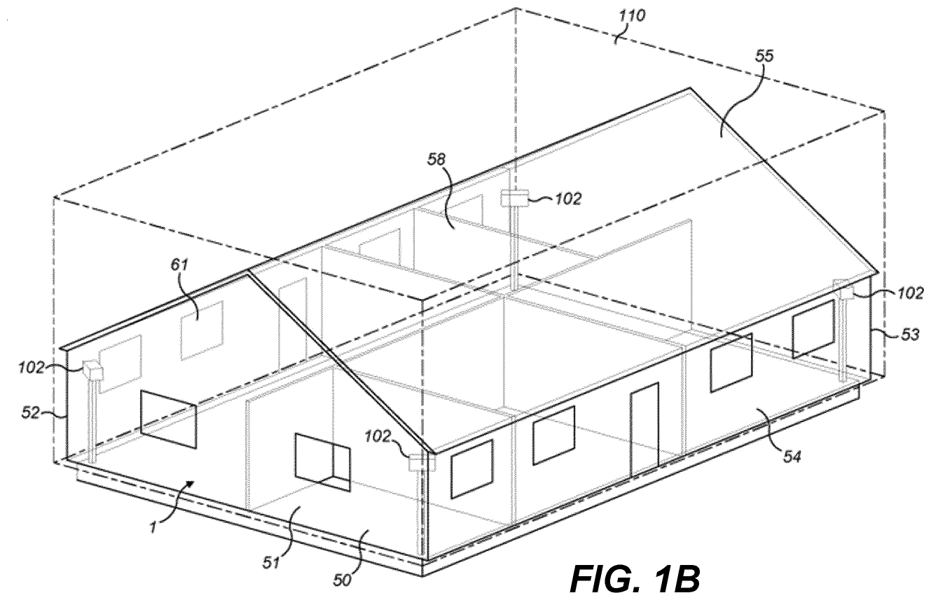

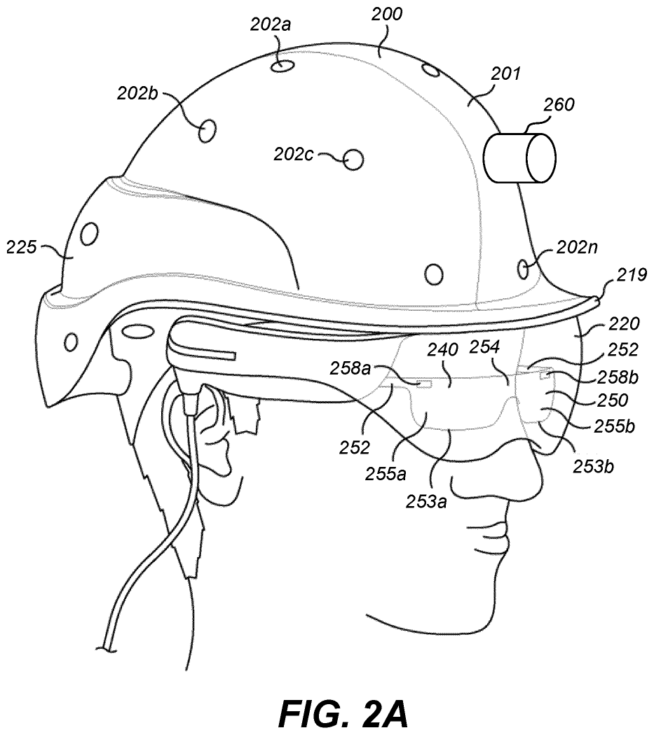

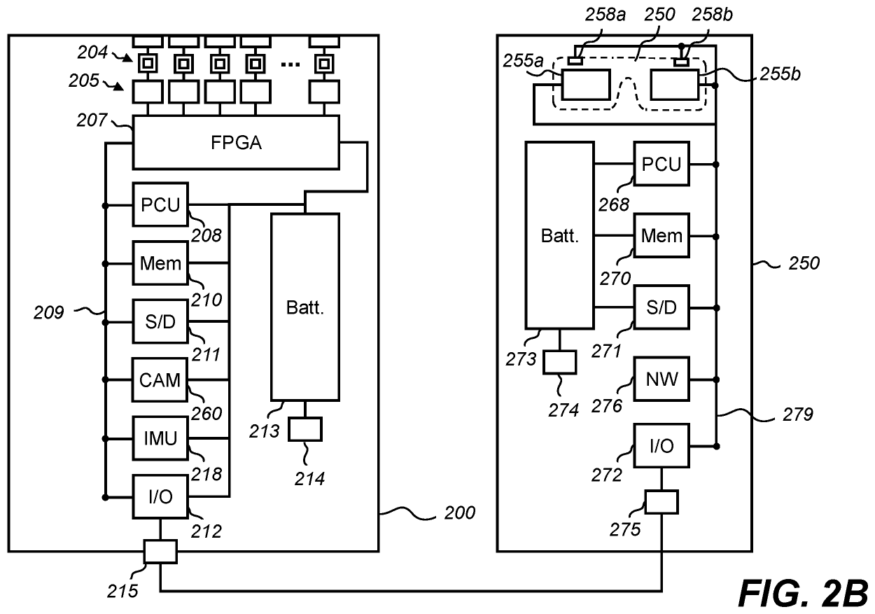

FIGS. 1A to 2B show an example of tracking that is performed on a construction site using a headset and a positioning system. It should be noted that the positioning system described in this example is provided for ease of understanding the present invention (e.g., may be seen as a prototype configuration) but is not to be taken as limiting; the present invention may be applied to many different types of positioning system and is not limited to the particular approaches described in the example. Although a headset is shown, the positioning system may be based on other wearable or carry-able devices.

FIG. 1A shows a location 1 in a construction site. FIG. 1A shows a positioning system 100 that is set up at the location 1. In the present example, the positioning system 100 comprises a laser-based inside-out positional tracking system as described in WO2019/048866 A1; however, this positioning system is used for ease of explanation and the present embodiment is not limited to this type of positioning system. In other implementations different positioning systems may be used, including optical marker-based high-accuracy positioning systems such as those provided by NaturalPoint, Inc of Corvallis, Oregon, USA (e.g., their supplied OptiTrack systems), and monocular, depth and/or stereo camera simultaneous localisation and mapping (SLAM) systems. SLAM systems may be sparse or dense, and may be feature-based and/or use trained deep neural networks. So-called direct systems may be used to track pixel intensities and so-called indirect systems may be feature-based. Indirect methods may be trained using deep neural networks. Examples of “traditional” or non-neural SLAM methods include ORB-SLAM and LSD-SLAM, as respectively described in the papers “ORB-SLAM: a Versatile and Accurate Monocular SLAM System” by Mur-Artal et al. published in IEEE Transactions on Robotics in 2015 and “LSD-SLAM: Large-Scale Direct Monocular SLAM” by Engel et al as published in relation to the European Conference on Computer Vision (ECCV), 2014, both of these publications being incorporated by reference herein. Example SLAM systems that incorporate neural network architectures include “CodeSLAM-Learning a Compact Optimisable Representation for Dense Visual SLAM” by Bloesch et al (published in relation to the Conference on Computer Vision and Pattern Recognition-CVPR-2018) and “CNN-SLAM: Real-time dense Monocular SLAM with Learned Depth Prediction” by Tateno et al (published in relation to CVPR 2017), these papers also being incorporated by reference herein. It will be understood that the base stations 102 may be omitted for certain forms of SLAM positioning system.

In FIG. 1A, the example positioning system 100 comprises a plurality of spaced apart base stations 102. In one particular implementation example, a base station 102 comprises a tracking device that is selectively operable to emit an omnidirectional synchronisation pulse 103 of infrared light and comprises one or more rotors that are arranged to sweep one or more linear non-visible optical fan-shaped beams 104, 105 across the location 1, e.g. on mutually orthogonal axes as shown. In the present embodiment, the base stations 102 are separated from each other by a distance of up to about 5-10 m. In the example of FIG. 1A, four base stations 102 are employed, but in other embodiments fewer than four base stations 102 may be used, e.g. one, two or three base stations 102, or more than four base stations. As described in WO2019/048866 A1, by sweeping the laser beams 104, 105 across the construction site 1 at an accurate constant angular speed and synchronising the laser beams 104, 105 to an accurately timed synchronisation pulse 103, each base station 102 in the laser inside-out positioning system may generate two mutually orthogonal spatially-modulated optical beams 104, 105 in a time-varying manner that can be detected by opto-electronic sensors within the tracked volume for locating the position and/or orientation of one or more tracked objects within the tracked volume. Other positioning systems may use other technologies to track an object using different technologies, including the detection of one or more active or passive markers located on the object as observed by tracking devices in the form of one or more cameras mounted at the base stations 102 and observing the tracked volume. In SLAM systems tracking may be performed based on a stream of data from one or more camera devices (and possible additional odometry or inertial measurement unit-IMU-data).

FIG. 1A also shows a user 2a, 2b. The user 2a, 2b wears a headset such as that shown in FIG. 2A that allows them to use the positioning system 100 to view, via a head-mounted display (HMD) of the headset, a virtual image of one or more internal partitions 52, 58 that are defined in the BIM and that may be aligned with part-constructed portions of a building 60. FIG. 1B shows a three-dimensional BIM 110 for a building 50 to be constructed. The building 50 has exterior walls 51, 52, 53, 54, a roof 55 and interior partitions, one of which is shown at 58. One of the walls 52 is designed to include a window 61. The BIM 110 is defined with respect to an extrinsic coordinate system, which may be a geographic coordinate system (e.g., a set of terrestrial coordinates) or a specific Computer Aided Design (CAD) reference origin. By configuring the alignment of the BIM 110 with the first location 1, a user 2a, 2b may see how a portion of the building in progress, such as window 61 matches up with the original three-dimensional specification of the building within the BIM. Adjustments may then be made to the building in progress if the building 50 is not being constructed according to the specification. This process is described in detail in WO2019/048866 A1.

FIG. 2A shows a hard hat 200 and a set of augmented reality glasses 250. These collectively form a headset for displaying an augmented reality BIM within a construction site. The headset is similar to that described in WO2019/048866 A1, with certain important differences for improved BIM display and configuration. It should be noted that FIGS. 2A and 2B shows just one possible hardware configuration; the method described later below may be performed on different hardware for different implementations.

The hard hat 200 comprises an article of headwear in the form of a construction helmet 201 of essentially conventional construction, which is fitted with a plurality of sensor devices 202a, 202b, 202C, . . . , 202n and associated electronic circuitry, as described in more detail below, for tracking the position of the hard hat 200. The helmet 601 comprises a protruding brim 219 and may be configured with the conventional extras and equipment of a normal helmet. In the present example, the plurality of sensor devices 202 track the position of the hard hat 200 within a tracked volume defined by an inside-out positional tracking system that is set up at a construction site, such as the positioning system 100 at the location 1 as described above in relation to FIG. 1A. However, it should be noted that alternative positioning systems may also be used, e.g. where the plurality of sensor devices 202 comprise passive and/or active markers or one or more camera devices for SLAM navigation. For example, although FIGS. 2A and 2B comprise particular sensor devices for particular positioning systems, these are provided for ease of explanation only; implementations may use any type or technology for the positioning systems, including known or future “off-the-shelf” positioning systems.

FIG. 2B shows the electronic circuitry that may form part of the headset of FIG. 2A. Again, this electronic circuitry may differ for different positioning systems; however, many positioning systems may share the general architecture described here. The electronic circuitry may be mounted within, upon, or in association with one or more of the hard hat 200 and the augmented reality glasses 250. For example, the left-hand side of FIG. 2B shows electronic circuitry that may be incorporated within or mounted upon the hard hat 200 and the right-hand side of FIG. 2B shows electronic circuitry that may be incorporated within or mounted upon the augmented reality glasses 250. The configurations shown in FIGS. 2A and 2B are provided for example only, and actual implementations may differ while retaining the functionality discussed later below. The electronic components of the hard hat 200 may be accommodated within a protected cavity 225 formed in the helmet 201 as shown in FIG. 2A. The hard hat 200 may have suspension bands inside the helmet 201 to spread the weight of the hard hat 200 as well as the force of any impact over the top of the head.

The example helmet 201 in FIG. 2A shows a set of n sensor devices 202i that are mounted with respect to the helmet 201. The number of sensor devices may vary with the chosen positioning system 100, but in the example shown in FIG. 1A, n may equal 32. In these examples, the sensor devices 202i are distributed over the outer surface of the helmet 201, and in certain examples at least five sensors may be required to track the position and orientation of the hard hat 200 with high accuracy. In the present example, as shown in FIG. 2B, each sensor device 202i comprises a corresponding photodiode 204 that is sensitive to infrared light and an associated analogue-to-digital converter 205a. The photodiodes 204 may be positioned within recesses formed in the outer surface of the helmet 201. In the present example of FIGS. 2A and 2B, digital pulses received from the analogue-to-digital converters 205 are time-stamped and aggregated by a Field Programmable Gate Array (FPGA) 207, which is connected to a processor 208 by a local data bus 209. The local data bus 209 also connects to a memory device 210, a storage device 211, and an input/output (I/O) device 212. The electronic components of the hard hat 200 are powered by a rechargeable battery unit 213. A power connector socket 214 is provided for connecting the battery unit 213 to a power supply for recharging. The I/O device 212 may comprise a dock connector 215 such, for example, a USB port, for communicatively coupling the electronic circuitry of the hard hat 200 to other devices and components. The local data bus 209 also connects to an (optional) inertial measurement unit (IMU) 218 of the kind found in virtual reality and augmented reality headsets, which comprises a combination of one or more accelerometers and one or more gyroscopes. The IMU may comprise one accelerometer and one gyroscope for each of pitch, roll and yaw modes. For different positioning system technologies, components 204, 205 and 207 may be replaced with corresponding sensor devices for those technologies.

Returning to FIG. 2A, in the present example, the headset comprises safety goggles 220, which serve not only to protect the user's eyes while on location in the building site, but also serve to protect the augmented reality glasses 250, which are mounted inside the goggles 220. In the present example, the goggles 220 are mounted to the helmet 201 such that they are recessed slightly behind the brim 219 to afford a degree of protection for the goggles 220. It will be understood that in embodiments where the augmented reality glasses 200 themselves are ruggedised and ready for construction, the safety goggles 220 may be omitted. In other embodiments, the helmet 201 may comprise a safety visor.

The augmented reality glasses 200 comprise a shaped transparent (i.e., optically clear) plate 240 that is mounted between two temple arms 252. In the present example, the augmented reality glasses 250 are attached to the hard hat 200 such that they are fixedly secured in an “in-use” position relative to the sensors 202i and are positioned behind the safety goggles 220. The augmented reality glasses 250 may, in some embodiments, be detachable from the hard hat 200, or they may be selectively movable, for example by means of a hinge between the hard hat 200 and the temple arms 252, from the in-use position to a “not-in-use” position (not shown) in which they are removed from in front of the user's eyes.

In the example of FIG. 2A, the transparent plate 240 is arranged to be positioned in front of the user's eyes and comprises two eye regions 253a, 253b, which are arranged to be disposed in front of the user's right and left eyes respectively, and an interconnecting bridge region 254. Attached to, or incorporated in, each of the eye regions 253a, 253b is a respective transparent or semi-transparent display device 255a, 255b for displaying augmented reality media content to a user as described below, whilst allowing the user to view his or her real-world surroundings through the glasses 250. The augmented reality glasses 250 also comprise lenses (not shown) positioned behind each display device 255a, 255b for viewing an image displayed by each display device. In some examples, the lenses may be collimating lenses such that an image displayed by each display device 255a, 255b appears to the user to be located at infinity. In some examples, the lenses may be configured to cause rays of light emitted by the display devices 255a, 255b to diverge, such that an image displayed by each display device 255a, 255b appears at a focal distance in front of the augmented reality glasses 250 that is closer than infinity. In the present example, the lenses are configured and arranged with the display devices 255a, 255b such that images displayed by the display devices 255a, 255b appear to be located at a focal distance of 8 m in front of the user. It should be noted that the configuration of the augmented reality glasses 250 may also change as technologies develop-they may be implemented by any set of hardware suitable for displaying an overlay of a virtual image for augmented reality. In other examples, similar systems may also be used for virtual reality applications.

In certain variations, eye-tracking devices may also be used. These may not be used in all implementations but may improve display in certain cases with a trade-off of additional complexity. The later described methods may be implemented without eye-tracking devices.

The example of FIGS. 2A and 2B shows additional eye-tracking hardware that may be used in variations. Within each eye region 253a, 253b, the transparent plate 240 carries a respective eye-tracking device 258a, 258b for tracking the position of the user's eyes when the hard hat 200 is worn. In particular, each of the eye-tracking devices 258a, 258b is configured to detect the position of the centre of the pupil of a respective one of the user's eyes for the purpose of detecting movement of the augmented reality glasses 250 relative to the user's eyes in use and to generate and output display position data relating the position of the augmented reality glasses 250 relative to the user's head. Those skilled in the art will be aware of numerous other solutions for tracking the position of the augmented reality glasses 250 relative to the user's head in use, including optical sensors of the kind disclosed by U.S. Pat. No. 9,754,415 B2 and a position obtaining unit of the kind disclosed by US 2013/0235169 A1, both of which are incorporated by reference herein. Monitoring movement of the augmented reality glasses 250 relative to the user's head may be useful in cases where the hard hat 200 is liable to move relative to the user's head but may not be required where the hard hat 200 is relatively secured to the user's head. In the present described variation, two eye-tracking devices 258a, 258b are provided, one associated with each of the user's eyes, but in other implementations, a single eye-tracking device may be employed associated with one of the eyes.

In terms of the electronic circuitry as shown in FIG. 2B, the transparent display devices 255a, 255b and eye-tracking devices 258a, 258b are connected to a local data bus 279 for interconnection with a processor 268, a memory unit 270, a storage device 271, and an input/output (I/O) device 272. Power for the electronic components is provided by a rechargeable battery unit 273, which is connected to a power connector socket 274 for connecting the battery unit 273 to a power supply for recharging. The local data bus 279 is also connected to a dock connector 275 and a network interface 276. The network interface 276 may comprise a wireless (WiFi) microcontroller. Although the example of FIG. 2B shows separate battery supplies, in other examples, a single power connector socket may be provided for both the hard hat 200 and the glasses 250, and in some examples, a single rechargeable battery unit may be provided for powering both sets of electronic circuitry. Again, if the eye-tracking hardware is not provided, the augmented reality glasses 250 may have a similar construction without eye-tracking devices 258a, 258b.

The present example of FIGS. 2A and 2B differs from the corresponding examples of WO2019/048866 A1 in that the headset also comprises a camera 260 that is mounted on the helmet 201 and, in this example, faces forward in line with the gaze of the user. Although one camera is shown, there may be one or more (or additional) camera devices that capture image data from one or more of the sides and the back of the helmet 201. The mounting shown in FIG. 2A is simply illustrative. For the methods described below, the camera 260 may be a relatively cheap, low-resolution grayscale device with a relatively low sampling frequency. In certain cases, the camera 260 may have dual functionality, for example being used for the methods described below and being used to implement a positioning system for tracking the headset. In this case, for example, the camera 260 may form part of a SLAM system for tracking the headset. Such a SLAM system may be used in a stand-alone manner and/or as a further positioning system in addition to the positioning system described with reference to FIGS. 1A to 2B. As such, although the camera 260 may be a relatively low specification device in certain examples, it may also comprise any one of a greyscale video camera, a Red-Green-Blue (RGB) video camera, an RGB and Depth (RGB-D) video camera, an event camera or any form of camera as discussed above. The camera 260 may also comprise a single monocular video camera or form part of a plurality of stereo cameras.

In FIG. 2B, the camera 260 is communicatively coupled to the local data bus 209 and is powered by the battery 213. Although in the example of FIG. 2B, the camera 260 forms part of the hard hat 200, in other examples it may form part of a separate module that is communicatively coupled to one or more of the hard hat 200 and the augmented reality glasses 250 (e.g., via a suitable wired or wireless interface such as a Universal Serial Bus—USB—or Bluetooth®).

The processor 208 is configured to load instructions stored within storage device 211 (and/or other networked storage devices) into memory 210 for execution. A similar process may be performed for processor 268. In use, the execution of instructions, such as machine code and/or compiled computer program code, by one or more of processors 208 and 268 implement the configuration methods as described below. Although the present examples are presented based on certain local processing, it will be understood that functionality may be distributed over a set of local and remote devices in other implementations, for example, by way of network interface 276. The computer program code may be prepared in one or more known languages including bespoke machine or microprocessor code, C, C++ and Python. In use, information may be exchanged between the local data buses 209 and 279 by way of the communication coupling between the dock connectors 215 and 275. It should further be noted that any of the processing described herein may also be distributed across multiple computing devices, e.g. by way of transmissions to and from the network interface 276.

### Marker Configuration

In examples described herein, a 2D marker is used to initialise or configure (i.e. set up) a transformation between a coordinate system used by at least one positioning system (such as the positioning system shown in FIGS. 1A to 2B and/or a SLAM system that may use camera 260 or a different set of devices) and a coordinate system used by the BIM. This transformation may be used to enable a map that is generated using the positioning system or the SLAM system to be referenced or registered to the BIM. The methods described in this section may be used instead of the calibration tool methods described in WO2019/048866 A1. In other examples, the calibration tool methods described in WO2019/048866 A1 may alternatively be used.

In a marker-based calibration, a user may simply turn on the headset and look around the construction site to align the BIM with a current view of the construction site. Hence, comparative initialisation times of minutes (such as 10-15 minutes) may be further reduced to seconds, providing what appears to be near seamless alignment from power-on to a user. Once the 2D markers are mounted in place and located, e.g. on an early permeant structure such as a column or wall, then they are suitable for configuring the headset over repeated use, such as the period of construction, which may be weeks or months.

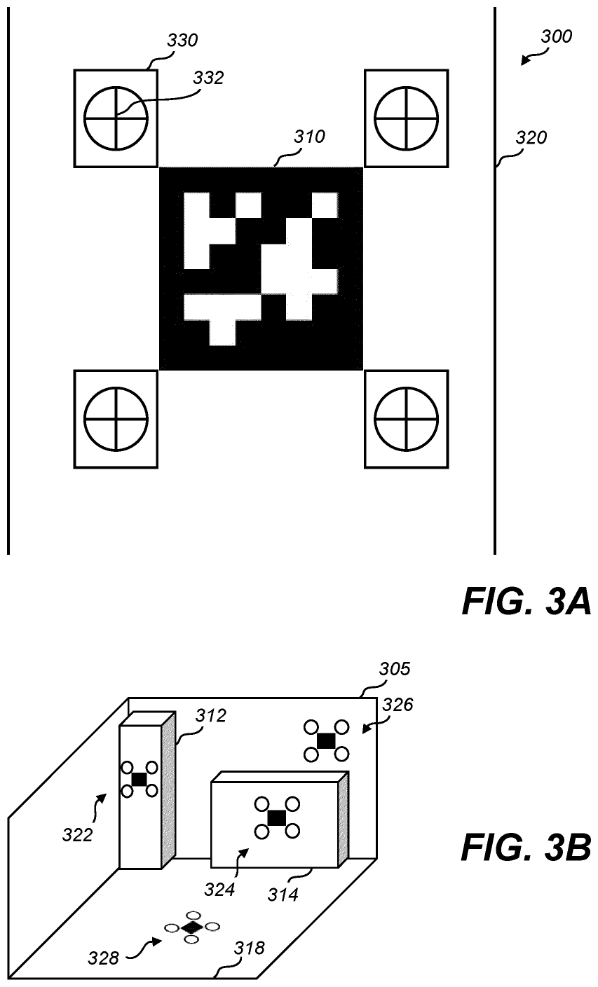

FIG. 3A shows a first example 300 of a 2D marker 310 that is mounted on a planar surface 320 within the construction site. These configurations are non-limiting and simply indicate some of the options that are possible with respect to marker placement. In FIG. 3A, the 2D marker 310 is surrounded by control markers 330 that comprise a target 332 for optical distance measurements. In the example of FIG. 3A, the control markers 330 are located such that the corners of the 2D marker 310 are visible but where there is a known distance between the target 332 location and the corner (e.g., in this case set by the fixed dimensions of the control marker 330). FIG. 3B shows how the example 300 may be located within a construction site. In FIG. 3B the construction site is an internal room 305, but in other examples the construction site may be an exterior area. In general, the 2D markers may be placed within any area of the construction site. FIG. 3B shows two structures within the room 305: a column 312 and a wall 314. There is also a floor 318. These are provided as an example and any form of structure may be used for the placement of markers, including ceilings and others. The 2D maker 310 and the control markers 320 are shown affixed to the column 312 at location 322 and to the wall 314 at location 324. They may also be affixed to walls of the room 305 as shown by location 326 or floors or ceilings as shown by location 328 on floor 318. Each area in the construction site may have one or more sets of 2D marker arrangements as shown. At a minimum, one such arrangement is positioned within each area. In this example, the 2D marker comprises an ArUco marker, but any form of marker may be used as described above.

In certain examples, marker-based calibration may be performed as described in GB2104720.4, which is incorporated by reference herein.

### Evolving Maps and Automatic Progress Capture

A method of updating a BIM with a point cloud is set out here. The method does not depend on a control marker being visible while the point cloud is generated (e.g., as per a laser or LiDAR sensor) nor does it require a device that is generating the point cloud to be positioned in one particular known or georeferenced point while the point cloud is generated.

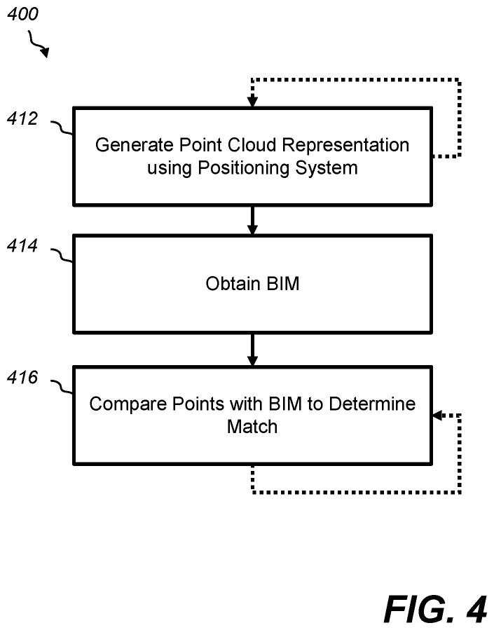

One example method 400 is shown in FIG. 4. The method comprises a first step 412 of generating a point cloud representation of a construction site. The point cloud representation being generated using a positioning system that tracks a device within the construction site. This device may comprise the headset described with reference to the examples above. In other implementations it may comprise a handheld device. The positioning system may use the technology described in WO2019/048866 A1, e.g. an inside-out tracking system using beacons, the technology described in GB2104720.4, e.g. a SLAM based system with calibration via the detection of markers within the environment, or another positioning technology. Preferably, the positioning technology is able to position the device with sub-millimetre accuracy. As a position of the device is known, point measurements using the device, e.g. using visual SLAM from a camera feed or device-mounted laser or LiDAR sensors, may be referenced to the position of the device at the point of capture or measurement. Hence, a sparse or dense point cloud map relative to the device may be generated as the device explores the surrounding environment, e.g. as a user wearing the device navigates the environment.

In one case, a point cloud representation may be generated by sub steps of tracking a headset and obtaining point measurements during the tracking of the headset. The headset may be tracked by the positioning system. The tracking of the headset may comprise determining a pose of the headset within a coordinate system used by the positioning system. The pose of the headset is used to determine a virtual image of the BIM to be displayed on a head-mounted display coupled to the headset. As described elsewhere herein, the BIM may be aligned with the pose using a calibrated transformation. To align the BIM with the view of the user wearing the headset, the BIM may be mapped to the coordinate system of the positioning system or the pose within the coordinate system of the positioning system may be mapped to the coordinate system of the BIM. The positioning system uses a first set of sensor devices to track the headset. For example, these may comprise: one or more of sensors 202, 204 and 205 as described with reference to FIGS. 2A and 2B; markers for optical tracking implementations; and/or cameras for SLAM implementations. The first set of sensor devices may comprise part of an off-the-shelf positioning system that outputs the pose of the headset within a defined coordinate system.

In a sub step of obtaining point measurements, point measurements may be obtained using a second set of sensors that are coupled to the headset. The second set of sensors may differ from the first set of sensors. The second set of sensors may form part of a point cloud generation system or mapping device that differs from the positioning system used to track the pose. The second set of sensors may operate using received electromagnetic signals. For example, they may comprise one or more laser devices and/or one or more camera devices. The point measurements comprise points within a measurement coordinate system defined by the second set of sensors. For example, the measurement coordinate system may be defined with respect to the second set of sensors and/or a device housing the second set of sensors. The point measurements may thus be provided as a three-dimensional point coordinate in the measurement coordinate system.

Following generation of a point cloud representation, i.e. a three-dimensional map comprising one or more measured points in three dimensions, the method 400 then comprises at step 414 obtaining a building information model representing at least a portion of the construction site. For example, this may comprise obtaining a BIM or BIM portion that is relevant to the presently explored environment, e.g. a room or building being constructed. The BIM may be obtained at the device, e.g. downloaded to a headset, or the point cloud representation may be communicated from the device to a server computing device where the BIM is accessible (e.g., in local storage or memory).

The method 400 then comprises at step 416 comparing one or more points in the point cloud representation with the building information model to determine whether the construction site matches the building information model. This may comprise a registration process where points, or objects or surfaces formed from the points, in the point cloud representation are compared to their same coordinate in the BIM. This may comprise a first sub step of mapping the measurement coordinate system to the positioning system coordinate system (i.e., the coordinate system for the positioning system where the pose of the headset is defined). This mapping may be performed using a further transformation (e.g., in addition to a calibrated transformation that is used to align the positioning system coordinate system and the BIM coordinate system). The further transformation may be defined, e.g. based on a known fixed geometry between the second set of sensors and the headset. For example, a centroid of a device housing the second set of sensors may be fixedly coupled to the headset allowing a constant spatial relationship between the measurement coordinate system and coordinates of the headset within the positioning system coordinate system to be defined. The first sub step may then be followed by a second sub step of aligning the point measurements with the BIM coordinate system. This may be performed by mapping the point measurements to the positioning system coordinate system using the further defined transformation and then mapping the point measurements in the positioning system coordinate system to the BIM coordinate system using the calibrated transformation. In this manner, the accuracy of a positioning system that tracks the headset for display of a virtual image may be leveraged to also register a point cloud with the BIM.

In one case, points in the point cloud may represent solid objects, e.g. a point on a surface or object. In a visual SLAM system, such as those referenced above, the point may be determined by processing images captured with a camera and determining a depth of surfaces or objects visible in those images; with a laser or LiDAR measurements, the point may be determined based on reflected laser light from a surface. As the points in the point cloud represent solid objects and surfaces, they may be compared with corresponding objects and surfaces within the BIM. If a point in the point cloud is deemed to be free space (e.g., unfilled) in the BIM, or vice versa, this may be indicated as a misregistration or deviation.

In examples, the method is performed iteratively over time such that the point cloud representation is generated dynamically as the device navigates the construction site. This is shown by the dotted line for step 412. Step 416 may also be performed repeated, as also indicated by the second dotted line. Hence, the BIM may be continuously checked against measured points and a result may be obtained in real-time rather than several hours or days. Steps 412 and 416 may be performed serially or independently. For example, steps 412 and 416 may be performed iteratively in parallel as a user navigates the construction site with the device. Matched points may be fixed within the point cloud, but unmatched points may be updated in the point cloud and any deviations iteratively assessed. As the point cloud measurements are registered with the BIM, points may be compared one-by-one as they are measured from the device and/or in batches. The method 400 is thus flexible and easy to implement.

The method 400 makes use of the fact that the headset is tracked within the construction site for the display of a virtual image, and so has an iteratively updated pose within the positioning system coordinate system. This may be provided as an output by the positioning system, which may be a closed system. A point measurement system then “piggy backs” off the tracking of the headset, allowing points measured using a second set of sensors (e.g., using a separate independent point measurement system) as the headset moves around to also be continually referenced to the BIM coordinate system. As such the generation of the point cloud happens transparently as a user wearing the headset navigates the construction site and views virtual images of the BIM (e.g., AR representations of the construction site).

In one case, the method comprises calibrating the positioning system using one or more locations in the construction site that have a known corresponding location within the building information model. For example, in the two-dimensional marker example of FIGS. 3A and 3B, the two-dimensional marker 310 may be located at a known location as it is exactly positioned with reference to one or more control markers 330 that are measured using surveying equipment, e.g. the position of the one or more control markers 330 may be known in a geographic coordinate system, where the BIM may also be defined with reference to the same system. As described above, when a headset with a camera views the two-dimensional marker, the marker construction allows one or more points representing the marker to be located in image data obtained from a camera, such as camera 260 in FIG. 2A, and thus identified within any point cloud generated using the image data (e.g., in a visual SLAM system). For example, the corners of the two-dimensional marker may be detected in images using known marker recognition functions in image processing libraries such as OpenCV library of functions and/or the marker coordinates with respect to the camera may be determined using functions such as the detectMarkers or estimate Pose SingleMarker function provided as part of a library of functions for use with ArUco markers, or the solvePnP function provided by OpenCV. If points on the two-dimensional marker are located with respect to the camera, they may also be transformed to a co-ordinate system with respect to a coordinate system of the positioning system, e.g. as described in GB2104720.4 using a known fixed spatial relationship between the camera and the headset. As points on the two-dimensional marker may also be georeferenced via the control markers 330, the location of the two-dimensional marker in an extrinsic or geographic coordinate system may be known (e.g., the two-dimensional marker may be exactly located such that each corner of the marker is a known or measured distance from a control marker whose position is measured in a geographic coordinate system using surveying equipment). In a visual SLAM system, image points (such as pixels) are projected onto points within a three-dimensional space and so the point locations of the two-dimensional marker within a point cloud map are present and identified within the map. Hence, the map contains georeferenced points via the two-dimensional marker. If a plurality (e.g., three or four or more) of points are georeferenced with respect to the marker, a transformation that adjusts the points in the map to the geographic coordinates of those same points may be determined (e.g., this may be performed using four corners of the two-dimensional marker). Hence, points within the point cloud map may be transformed with the determined transformation and are now represented in a coordinate system that matches the coordinate system of the BIM. Once this is achieved points in the map may be compared to points in the BIM, as they are both aligned to the same coordinate system (e.g., a geographic coordinate system).

In another example, calibration of a device such as a headset may be performed as described in WO2019/048866 A1, whereby a plurality of known locations in a construction site, i.e. points with known geographic coordinates measured using surveying equipment, are measured with a handheld device that is tracked by the positioning system. Hence, these known locations have locations within the positioning system coordinate system (e.g., an intrinsic coordinate system) and an extrinsic coordinate system (e.g., a geographic coordinate system that is also used as the reference coordinate system for the BIM). A transformation can then be determined between coordinates in the positioning system coordinate system and the extrinsic coordinate system as per the marker example above. Hence, locations (i.e., 3D coordinates) in the positioning system coordinate system may be transformed to align with the BIM.

As described later herein, following an initial calibration (e.g., as described above), future calibration may also be performed using measured structures that are approved by a user. For example, point cloud measurements mapped to the BIM may allow structures such as walls, ceilings, or doors to be approved as matching the BIM and/or the BIM may be updated to reflect point cloud measurements. During future navigation, if point cloud measurements are made that are deemed to form part of the approved structure (e.g., lie in a plane representing a wall, ceiling or door), then these can be used to update, refine, or generate the calibrated transformation. For example, point measurements may be mapped to the positioning system coordinate system using the defined further transformation, and so exist as points within the positioning system coordinate system with known locations in both the positioning system coordinate system and the BIM coordinate system, allowing a transformation between the two coordinate systems to be updated or generated. In one case, a calibrated transformation may be constantly refined using a plurality of mappings between the positioning system coordinate system and the BIM coordinate system.

In both the cases above, once calibration has been performed, e.g. a transformation determined that maps 3D coordinates in the positioning system coordinate system to the BIM coordinate system, locations within the positioning system can be compared with corresponding locations in the BIM. This means that any point measurement device coupled to the tracked device, e.g. laser devices coupled to a hard hat or a camera coupled to a hard hat for SLAM, can generate a point cloud map reference to the tracked device. For example, a laser scanner fixably coupled to a hard hat as shown in FIG. 2A may measure a location of a point on a wall using a projected laser beam. This results in a point location that is referenced to the laser scanner. As the fixed relationship between the laser scanner and the hard hat is known (e.g., may be set as part of a hard hat design), the point location can also be referenced to the hard hat and a centroid of the hard hat that is tracked by the positioning system. As the locations within the positioning system, such as the centroid are transformed to align with the BIM coordinate system, the other fixed relationships between the laser scanner and the hard hat may be used to align the point measurements to the coordinate system of the positioning system and thus to the BIM coordinate system. For example, a further transformation may be applied to point measurements from the laser scanner to align with the BIM coordinate system using the fixed relationships (e.g., as represented by a transformation) and the calibration transformation.

The methods described here may operate with sparse or dense point clouds. This makes them useable with sparse or dense laser scanner data, sparse or dense SLAM mapping, and sparse or dense LiDAR data. As a first group of points (i.e., an initial pose of a headset) is positioned accurately in space (e.g., via the positioning system), any number of points may be referenced to those first group of points. Furthermore, examples may couple a scanner such as a portable laser scanner, LiDAR device or any form of depth sensor may be built into a Head Mounted Display (HMD), e.g. a headset or HMD as shown in FIG. 2A. Tracked devices also need not be head mounted. For example, implementations may provide a tracked handheld scanner or sensor that provides point measurements. Cameras may also be used to infer depth measurements for 3D coordinate maps, e.g. such as within SLAM methods. The positioning system described in examples may be any positioning system including an “outside in” tracking system that uses external devices such as beacons (see WO2019/048866 A1) or an “inside out” tracking system, such as the camera-based HoloLens® device provided by Microsoft Corporation.

In examples, an initial pose of a device may be obtained based on a control point or a vision-detected marker. The device is then navigated around the site, e.g. as it is held or worn by a user. During movement of the device a 3D map consisting of 3D points is constructed (e.g., via vision or SLAM methods or via point measurement devices coupled to the device). SLAM methods may incorporate loop closures to make the 3D map more accurate. Due to the calibration and reference transformations described above, the 3D points in the 3D map are aligned with the coordinate system of the BIM. The BIM may thus be overlaid over the 3D map, e.g. either automatically or manually.

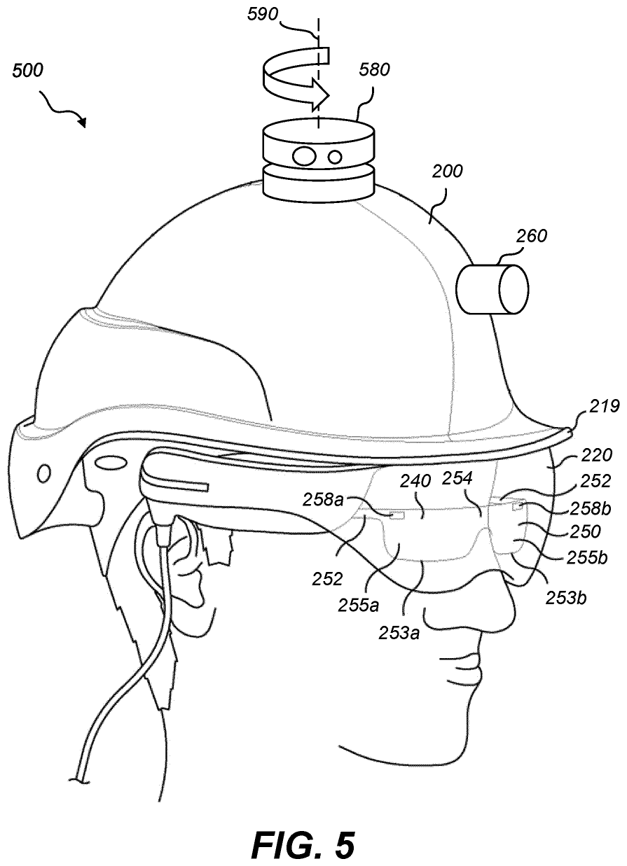

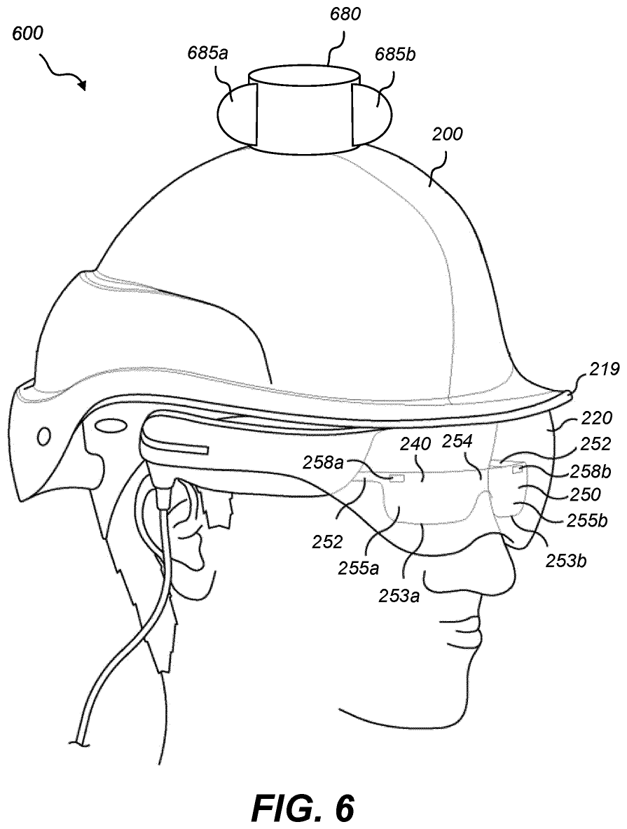

FIGS. 5 and 6 show two alternative examples of a headset for building a point cloud for comparison with a BIM. Both FIGS. 5 and 6 show an adaptation of the headset shown in FIGS. 2A and 2B, and reference numerals from FIGS. 5 and 6 relate to corresponding features in the described examples. Certain features are omitted for clarity. FIG. 5 shows a first example 500 whereby a second set of sensors for point measurements within the construction site using received electromagnetic signals comprise a rotating laser scanner 580. The laser scanner 580 may comprise a 360-degree LIDAR sensor, such as those supplied by YDLIDAR (Shenzhen EAI Technology Co., Ltd. of Shenzhen, China), SLAMTEC (Shanghai Slamtec Co., Ltd. Of Shanghai, China) including the RPLIDAR range, or developed as part of the OpenLIDAR project. In FIG. 5, the laser scanner 580 is fixedly coupled to the top of the hard hat 200 and is able to rotate around axis 590. During rotation point measurements of the construction site around the user may be made, e.g. using the electronic distance measurement devices encompassed within the laser scanner 580. The output of the laser scanner 580 is thus a set of point cloud measurements that are referenced to a coordinate system defined by the laser scanner 580 (e.g., typically a centroid of the laser scanner 580 that lies on the axis 590 and is set as part of the product). An origin of this coordinate system defined by the laser scanner 580 may then be mapped to an origin of a coordinate system of a positioning system for the hard hat 200 (e.g., a centroid of the hard hat may be tracked within the positioning system coordinate system) to map point measurements from the laser scanner 580 into the coordinate system of the positioning system, where they may then be mapped to the BIM coordinate system using the calibrated transformations for headset tracking. Although this example shows a rotating laser scanner, in other examples a laser scanner may comprise multiple emitters and receivers distributed around the hard hat or a coupled laser scanning device. In certain examples, one or more single laser distance measurement devices may be coupled to the hard hat.

FIG. 6 shows a second example 600. In this case, a wide-angle camera device 680 is fixedly coupled to the top of the hard hat 200. The wide-angle camera device 680 in this example comprises two 180-degree wide angle image capture devices 685a, 685b to enable a 360-degree view of the scene around the hard hat 200 to be captured. In this case, image processing may be applied to images captured from the wide-angle camera device 680 (e.g., frames of streamed video or periodically captured images) to determine point measurements in the space surrounding the hard hat 200. For example, the wide-angle camera device 680 may comprise an omnidirectional camera. The point cloud measurements may be made using SLAM approaches, including those discussed earlier herein, or neural network approaches, such as those comprising neural radiance fields (so-called NeRF models). Although the example of FIG. 6 is shown as a 360-degree camera comprising two 180-degree wide-angle image capture devices, other camera configurations are possible. This include movable cameras, scanning cameras, omnidirectional cameras, and other wide-angle configurations.

It should be noted that in FIGS. 5 and 6, the sensors 202 are not shown for clarity. These may or may not be provided depending on the choice of positioning system. For example, in one case, they may be provided in addition to the laser scanner 580; however, in another case, the laser scanner 580 may only be provided with a separate camera device 260 supplied for tracking the headset using SLAM methods. In FIG. 6, sensors such as sensors 202 may be provided or they may not be provided. As an alternative to sensors 202 in FIGS. 2A and 2B, the example 600 of FIG. 6 may use a separate camera such as 260 for SLAM methods or may even use the wide-angle camera device 680 for both headset tracking and point cloud measurement. In preferred examples, the point cloud measurement device and the headset positioning system are independent, e.g. comprise separate systems that output point and/or pose parameters.

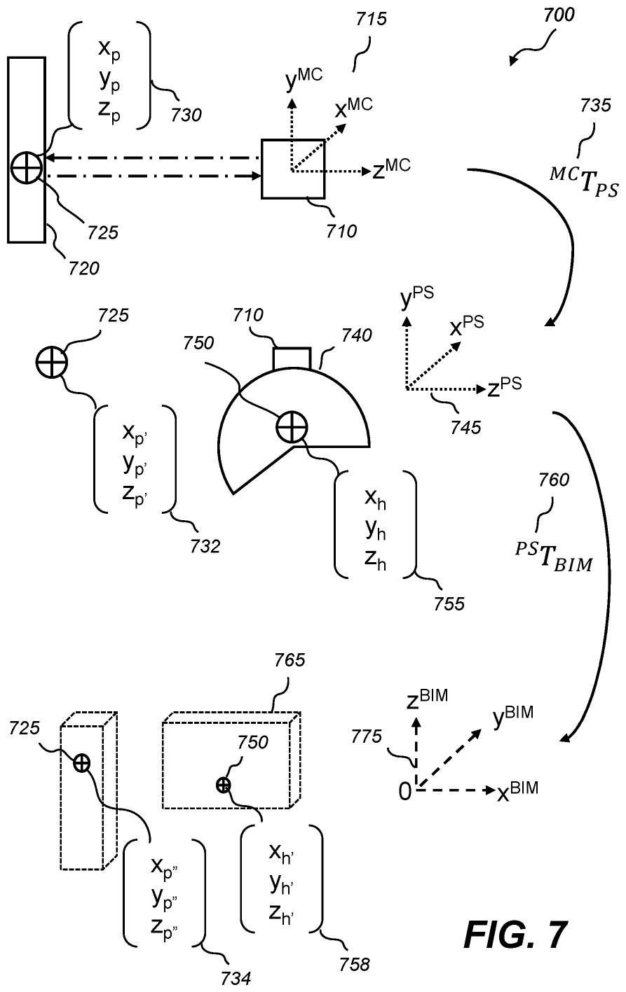

FIG. 7 shows a schematic example 700 of point cloud generation. Three different spaces are shown: a point cloud measurement space, a headset tracking space, and a BIM space. Within the point cloud measurement space, a point measurement device 710 (which may comprise the second set of sensors for point measurements as described above) measures point locations within a measurement coordinate system 715. In this example, the point measurement device 710 comprises an electronic distance measurement device that emits an electromagnetic beam (e.g., a laser signal) and measures any beam reflected from objects or surfaces within the construction site. For example, FIG. 7 shows a wall 720 and in the example 700, the point measurement device 710 is near the wall so a point 725 on the wall is measured via a reflected electromagnetic beam. For example, distances may be measured to a surface by comparing wave properties of the emitted and received beams, such as changes in phase and/or time taken between emittance and receipt. The point measurement device 710 is thus adapted to measure a three-dimensional coordinate 730 for the point within the measurement coordinate system 715.

Now, in the example of FIG. 7, as with the examples of FIGS. 5 and 6, the point measurement device 710 is fixedly coupled to a headset 740 (e.g., to the top of a hard hat as an article of headwear that forms part of the headset). In the example, the headset 740 is tracked within the construction site using a positioning system. The positioning system operates within a positioning system coordinate system 745. For example, a centroid (i.e., central point) 750 of the headset 740 has at least a coordinate 755 within the positioning system coordinate system 745. The coordinate 755 forms part of the pose of the headset. Although not shown for clarity, in a 6 degree of freedom (6DOF) positioning system, a plurality of angular measurements may also be provided, and/or additional points on the headset to indicate an orientation within the positioning system coordinate system 745 (e.g., as described in more detail above). The pose of the headset (e.g., as represented by 755) may be an output of the positioning system.

As part of the proposed examples, a transformation 735 is defined that maps from points in the measurement coordinate system 715 to points in the positioning system coordinate system 745 that form the headset tracking space. For example, the transformation 735 may comprise a matrix multiplication that is applied to an extended 4D vector (e.g., the coordinate 730 with 1 as the fourth entry). The transformation 735 may be defined based on the construction of the headset (e.g., may be based on a CAD design for the headset or may be measured following attachment of the point measurement device 710). The transformation 735 is used to map the coordinate 730 of the point 725 from the measurement coordinate system 715 to a corresponding coordinate 732 in the positioning system coordinate system 745.

The lower section of FIG. 7 shows a BIM space. In this space, a BIM 765 is defined within a BIM coordinate system 775. The BIM coordinate system 775 may be a geographic or georeferenced coordinate system. A calibrated transformation 760 maps from the positioning system coordinate system 745 to the BIM coordinate system 775. During display of a visual image the calibrated transformation 760 may be used to align a virtual image of the BIM 765 with a view direction of a user wearing the headset 740. To do this the pose of the headset 740 may be mapped into the BIM space using the calibrated transformation 760. FIG. 7 shows the location of the centroid 750 as a coordinate 758 in the BIM coordinate system 775. As well as mapping the pose, the location of point 720 may also be mapped a further time into the BIM coordinate system 775 using the calibrated transformation 760. FIG. 7 shows a coordinate 734 of the point 725 in the BIM coordinate system 775 along with the coordinate of the centroid 750. As such, the point measurements are aligned with the BIM using the defined transformation 735 and the calibrated transformation 760 such that the point measurements and BIM reside within a common coordinate system (at the bottom of FIG. 7—the BIM coordinate system 775). Hence, the point measurements and the BIM may be compared in the common coordinate system.

Although in FIG. 7 the BIM coordinate system 775 is shown as the common coordinate system, it is also equally possible to map the BIM 765 to one or more of the positioning system coordinate system 745 and the measurement coordinate system 715 by using the inverse of the transformations 735, 760.

In certain examples, the methods described herein may include identifying one or more key features within the point cloud representation and using the one or more key features as a reference for registration of the building information model with the point cloud representation. For example, certain points, groups of points, objects, or surfaces within the 3D may be identified as key features or primary points. These may comprise features such as corners, edges, and other change points in the 3D map. The identification of key features may be performed automatically (e.g., based on 3D change point detection) or manually (e.g., by a user providing input that indicates that certain objects or points being viewed in augmented reality are to be used as key features). This may help to reduce the number of deviations that are reported, e.g. a plurality of measured points representing a wall may be grouped as a plane or mesh surface that best fits the points, where the plane or mesh surface is a key feature. Key features may also comprise points that represent particular marks in the construction site, e.g. external marks or references, key parts of the build etc. Key features may be selected as distinguishable points in the 3D map. Key features may be used to identify elements in the real world that may be quickly and easily compared with the BIM model. For example, rather than hundreds or thousands of points, a plane representing a wall in the measured 3D map may be compared with a plane in the BIM that also represents the same wall in a design, and a 3D distance measure between the two planes used to measure a deviation. If the distance measure is within a defined tolerance, it may be accepted and if it is outside the defined tolerance, it may be rejected. Alternatively, the two surfaces may be viewable (e.g., either highlighted in an augmented reality view on the HMD or later at a computing device) for manual approval and/or modification of the BIM. The comparison between points (e.g., as points or in the form of key features) may form the basis of a deviation analysis. The deviation analysis may be performed in real-time (or near real-time) or as part of post processing. The benefit of the present methods is that there is no time restriction; other comparative solutions may only be performed as part of post processing.

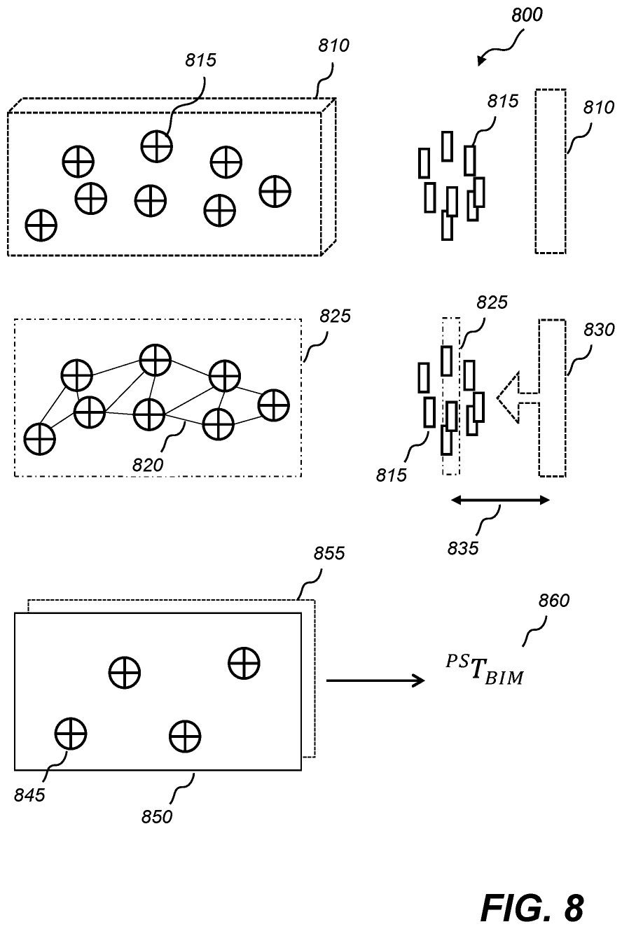

FIG. 8 shows a schematic example 800 of comparing measured points to a BIM in a common coordinate space, and then using an approved BIM update for computing a calibrated transformation. At the top section of FIG. 8, a portion of a BIM 810 is to be compared to a plurality of measured points 815. For example, the points 815 may be measured using one of the apparatus of FIG. 5 or 6 and mapped to a common coordinate space as shown in FIG. 7. In the present case, to facilitate the comparison, a mesh or surface is fitted to a plurality of points within the point measurements and then the mesh or surface is compared to a corresponding portion of the BIM. The surface or mesh may be fitted to represent one or more of a wall, a ceiling, or a door.

In the middle section of FIG. 8, the process of fitting a mesh or surface to the measured points is illustrated. In one case, a polygonal mesh 820 may be fitted to the points. This may be achieved using any known mesh fitting method. In this case, if the mesh 820 is within a tolerance of a planar surface such as 825, the planar surface may be taken as representative of the mesh 820. In certain cases, constraints may be defined for certain types of objects, such that surfaces should be horizontal or vertical, and so if points are within a predefined tolerance a horizontal or vertical surface is fitted. In certain cases, a mesh may not be fitted prior to the fitting of a surface or other geometrical model. For example, points may be directly fitted to horizontal or vertical planes (e.g., as defined in the common coordinate space such as the BIM coordinate system). In FIG. 8, points 815 are fitted to planar vertical surface 825. The vertical surface 825 may then be compared to the portion of the BIM 810.

In certain examples, the headset may indicate to a user via the head-mounted display a match between the surface or mesh and the portion of the BIM. For example, the user may be presented with a virtual image showing the location of the fitted surface 825 and the BIM portion 810. In once case, the display of the fitted surface 825 and the BIM portion 810 may be based on a distance 835 between the two structures within the common coordinate space. For example, in one case, if the distance 825 is at or below a predefined threshold, such as 1 mm, the two structures may be deemed a match automatically. In that case, or an alternative case, if the distance 825 is over the predefined threshold, then the distance 825 and the two structures may be graphically indicated to the user within the virtual image (e.g., within an AR environment). In one case, difference tolerance ranges may be associated with different visual displays. For example, a distance 825 within a first range above the predefined lower threshold may be indicated as a difference but shown as a match to be approved to update the BIM with an actual location. In this case, a distance 825 within a second range above the range may be indicated as a difference that requires further investigation or redoing (and thus recommended not to approve the match). In one case, a mismatch between a fitted mesh or surface and the corresponding portion of the BIM (e.g., the closest surface to the fitted mesh or surface within the BIM) may be shown to a user and the user may be given an option to approve or disapprove the mismatch. If the mismatch is approved, e.g. via a verbal or control input to the headset, then, responsive to the approval, the portion of the BIM 810 may be updated as shown in 830 based on the measured position of the surface or mesh, e.g. in FIG. 8, the parameters that define wall 810 in the BIM are adjusted such that they are coincident with the measured fitted surface 825. If the mismatch is not approved, then the BIM may not be updated. However, the portion 810 of the BIM may be labelled as a discrepancy.

Therefore, as the headset is constantly tracked, its pose, orientation, position and rotation is known, i.e. via the positioning system. Using this it is possible to update the BIM in real time by “signing off” works (i.e., as represented by points or key features) that match the BIM (e.g., within a specified tolerance), and also to modify points in the BIM to reflect the new position of points that do not match the BIM (e.g., a wall may be out of alignment). This may be performed via the HMD as shown in FIG. 2A. In this manner, the BIM becomes an evolving “live” model that accurately reflects a building under construction.

In addition, in certain cases, points, surfaces, or meshes that are approved by a user and/or that are automatically deemed a match with the BIM may be used to update, refine, or generate the calibrated transformation for use mapping the pose to the BIM. This is shown at the bottom of FIG. 8. This may follow a process similar to the matching of the points and the BIM described above.

To update, refine, or generate the calibrated transformation for use mapping the pose to the BIM, the location of three or more points (four or more preferred) in both the positioning and BIM coordinate systems need to be known (e.g., pairs such 732 and 734). Pairs of coordinates may thus be compared to determine a best fit transformation (e.g., via least squares or other optimisation methods) that maps between the two pairs of points. During navigation, points 845 may be measured with the point measurement device and these may be fitted to a surface or mesh 850 as described above. These may be similar or the same points, or other points that are deemed to fall within a tolerance of a modelled mesh or surface. However, in this case, the measured points are mapped to the positioning system coordinate system but not the BIM coordinate system. If there has been a match, or the BIM has been updated following a mismatch, the fitted surface or mesh 850 has an approved corresponding surface in the BIM, shown in FIG. 8 as 855. Hence, fitted surface or mesh 850 and BIM surface or mesh 855 form sets of corresponding points that may be defined in two different coordinate spaces—e.g. respectively, the positioning system coordinate space (such as 745 in FIG. 7) and the BIM coordinate space (such as 775 in FIG. 7). These sets of corresponding points may then be used as input to generate or refine the positioning system to BIM transformation. This may increase the accuracy of an initial calibration transformation. It may also allow calibration to be performed without the need for markers or detection of initial georeferenced points, thus speeding up start-up times for displaying AR images when entering a previously “signed off” area of the construction site. Fitting simple geometric models to the point cloud may allow for large areas of the point cloud and the BIM to be compared, without checking whether individual points are within tolerance. This can speed up the approval process, reduce computation demands and/or allow a user to concentrate on parts of the point cloud that do not represent well-defined geometric structures (the latter being regularly found in construction sites). For example, even if the method is applied to simple structures such as ceilings, walls, floors, or doors this may account for a large number of the acquired point cloud measurements and so facility building sign-off as a user explores the construction site at different points in time during construction.

As described herein, tracking using a positioning system may be performed using SLAM based methods including, but not limited to, neural-network-based SLAM and measurement of points may be performed using a portable laser scanner or LiDAR inside the HMD instead of comparative laser scanning instrument (e.g., the RTC 360 as provided by Leica Geosystems) to produce a point cloud. In other examples, tracking may be based on a hand held, and/or point measurements may be made based on depth values generated from computer vision processing.

In an example operational flow, a user may put on a hard hat as shown in FIG. 2A, go (roughly) to an initial position (either a control marker or a location where a QR code is visible), log the position or look at the QR code with the camera, load the latest BIM (which may be automatically loaded based on marker detection or manually chosen by user), walk around, build a map and compare the map with the BIM model. In a space that has already undergone an approval process, approved or accepted match structures may be used as well as, or instead of a control marker or QR code to perform an initial calibration. As methods may be performed in real time with sparse point clouds, they are easier to implement, require fewer points, and matching may be performed without resource intensive computer hardware. For example, a column may be measured as 1000 points with a laser scanner, but a sparse (point) map as generated herein may only use 10 points or key features to represent the column (e.g., a column may be indicated as a geometric surface using a defined column model). This makes it much easier to compare the measured points against the BIM. In certain cases, key features that are very distinctive may be extracted that also have associated meta data pertaining to their position in space. Based on the key features and their position in space, a small section of space in the BIM may be identified to reduce the comparison points and hence the required processing power. Another method may involve constructing meshes, (e.g., of the faces of the column in the aforementioned example) in both the point cloud and the BIM, and the position of these meshes are compared.

As a positioning system allows the pose (e.g., position, rotation and/or orientation) of a headset to be known and the point cloud capture may be continuously registered, updates to the BIM may be made in real time. Using the point cloud data and real time geolocation, it is possible to not only assess whether a surface or object is in or out of tolerance, but the BIM may also be updated to the as-built position in real time. In certain case, when signoff is done that the built version is fine, key features (like edges or surfaces) can be used to transform the existing BIM data to the actual built position.

Although certain examples have been described herein with reference to a classical point cloud representation (e.g., a 3D point map), the methods may alternatively make use of neural network map representations such as NeRF, which is described in the paper “NeRF: Representing Scenes as Neural Radiance Fields for View Synthesis” by Ben Mildenhall et al, ECCV 2020, which is incorporated herein by reference.

As described with reference to FIG. 8 above, in certain examples, one or more points in the point cloud representation that are determined to match the building information model may used as a reference for registration of the building information model with the point cloud representation. For example, as the BIM is a map of features referenced to an extrinsic coordinate system such as a geographic coordinate system (e.g., BIM features are georeferenced), then matched points or key features may be used as calibration points for iterative transformation computation and BIM-to-positioning system or BIM-point measurement alignment. For example, once a map is built, the next time one or more points in a point cloud are measured or points are derived from an image (e.g., via SLAM projection), it is not required to re-register to the BIM, as accepted (i.e., matched) points or key features in the existing map may be used as a georeferenced. Hence, as the device (e.g., headset) navigated the construction site and is localised in real time (e.g., via SLAM or other positioning), the known positions of accepted points are known and so point locations with a different time stamp and different coordinate can be referenced to the accepted point location. This means that two dimensional markers and/or control points may not be required around a construction site for calibration reference, as the accepted points or key features themselves in the point cloud act as a focal point for geolocation. In this manner, the device may be constantly in the site coordinate system. This also makes it possible to navigate between difference zones (e.g., different beacon volumes as shown in FIG. 1A).

The examples described herein may be compared to traditional SLAM mapping wherein a generated 3D would change over time. In the present examples, However, once a feature has been determined to have been installed correctly, these points can exist as permanent features throughout the map. Also, localisation within SLAM based on these points may be more heavily weighted. Also, if key features are used, such as surface or meshes for walls, ceilings, doors etc. then this simplifies the analysis as points may be represented by a geometric definition (e.g., a plane equation or matrix) and all points within the surface or mesh may be accepted and used as a future reference.

In certain examples, the degree of confidence in the point cloud is determined by its position relative to the BIM. For example, if a point cloud wall exactly matches the BIM (e.g., within some define tolerance), this can be signed off to become a permanent feature. In this manner, maps “evolve” over time (i.e., dynamically), leveraging accepted points and the BIM as part of the map of the space. It is often the case that one location in the construction site is inspected several times during construction to approve different stages of the build. In these cases, approvals made at early milestones are able to help speed up calibration of later inspections, as approved points, meshes, or structures may be used to determine the calibrated transformation for tracking of the pose.

In certain examples, the positioning system may form part of a plurality of positioning systems used by the headset. These may comprise positioning systems of the same type or of different types. Positioning systems as described herein may be selected from one or more of the following non-limiting examples: a radio-frequency identifier (RFID) tracking system comprising at least one RFID sensor coupled to the headset; an outside-in positioning system; an inside-out positioning system comprising one or more signal-emitting beacon devices external to the headset and one or more receiving sensors coupled to the headset; a global positioning system; a positioning system implemented using a wireless network and one or more network receivers coupled to the headset; and a camera-based simultaneous localisation and mapping (SLAM) system. The headset may use two different SLAM positioning systems, a SLAM positioning system and a RFID positioning system, a RFID positioning system, and a WiFi positioning system, or two different tracked volume positioning systems covering overlapping tracked volumes. In these cases, a BIM-to-positioning transformation may be determined for each positioning systems.

The examples described herein provide improvements over comparative model matching and update methods. The examples may use the fact that certain key structures within a construction site, such as walls and columns, are surveyed at initial milestone points during construction. Examples may involve the placing and measurement of 2D markers or control markers as part of this existing surveyance for the calibration of a positioning system. For example, once a total station is set up in a space, making multiple measurements of additional control marker is relatively quick (e.g., on the order of seconds). Two-dimensional markers may be usable for rapid configuration of a headset for displaying and/or comparing the BIM during subsequent construction, such as interior construction where accurate placement of finishes is desired.

According to one aspect of certain unclaimed examples, a method comprises: generating a point cloud representation of a construction site, the point cloud representation being generated using a positioning system that tracks a device within the construction site; obtaining a building information model representing at least a portion of the construction site; and comparing one or more points in the point cloud representation with the building information model to determine whether the construction site matches the building information model, wherein the point cloud representation is generated dynamically as the device navigates the construction site.

The method may comprise calibrating the positioning system using one or more locations in the construction site that have a known corresponding location within the building information model. Said calibrating may comprise one or more of: locating a handheld device that is tracked by the positioning system at a plurality of known locations within the construction site; and capturing an image of a two-dimensional marker with a camera coupled to the device, the two-dimensional marker being located in a known position and orientation with reference to a plurality of known locations within the construction site.

In certain variations of the method, the point cloud representation is generated by a camera-based mapping system, a camera for the camera-based mapping system being coupled to the device within the construction site. The camera-based mapping system may be a simultaneous mapping and localisation (SLAM) system.

In certain variations of the method, the device comprises a sensor to measure a depth of one or more locations and/or a laser device to measure a point from the device. The device may comprise an augmented reality headset, wherein a view of the building information model is projected onto a display of the headset. The augmented reality headset may be coupled to an article of headwear such as a hard hat.

In certain variations, the method may comprise identifying one or more key features within the point cloud representation, and using the one or more key features as a reference for registration of the building information model with the point cloud representation. The one or more key features may comprise one or more of objects and surfaces within the construction site. The method may additionally comprise generating a mesh representation based on points within the point cloud representation, wherein the mesh representation is used as a key feature. This step may comprise generating a mesh representation based on the building information model, wherein said comparing comprises comparing the mesh representations. The one or more key features may be used to update the building information model.

In certain variations of the method, the one or more points in the point cloud representation that are determined to match the building information model are fixed within the point cloud representation and are not modified as the device navigates the construction site. The point cloud representation may be generated using a neural network representation. In one case, one or more points in the point cloud representation that are determined to match the building information model are used as a reference for registration of the building information model with the point cloud representation.

According to another aspect of certain unclaimed examples, a headset is provided for use in construction at a construction site, the headset comprising: a set of sensor devices for a positioning system, the set of sensor devices operating to track the headset at the construction site; and at least one mapping device to receive electromagnetic signals from the construction site and to generate data representative of a three-dimensional map of the construction site; and wherein the set of sensor devices provide data to determine a pose of the headset with respect to the building information model in three dimensions, and wherein the data from the at least one mapping device is combinable with the three-dimensional building information model to update and/or augment the building information model.

In this aspect, the set of sensor devices may comprise the first set of sensor devices for the positioning system as described above and the at least one mapping device may comprise the second set of sensors devices for point cloud measurement as described above.

In this aspect, the headset may also comprise a head-mounted display for displaying a virtual image of a three-dimensional building information model. The pose may be used to align the three-dimensional dimensional building information model with a location and head direction of a user, e.g. to display the virtual image. The headset may also comprise an article of headwear such as a hard hat. The mapping device may be mounted at the top of the hard hat.

In one variation of the above aspect, at least the mapping device comprises one or more wide-angled camera devices. For example, the mapping device may comprise a camera device with a 360-degree field of view. In one case, the set of sensor devices and the at least one mapping device may jointly comprise a camera device with a 360-degree field of view. In other cases, the set of sensor devices and the at least one mapping device comprise different sets of devices.

In one variation of the above aspect, the mapping device may comprise a laser device for performing electronic distance measurement. The laser device may be configured to sweep a field of view of 360-degrees.

If not explicitly stated, all of the publications referenced in this document are herein incorporated by reference. The above examples are to be understood as illustrative. Further examples are envisaged. Although certain components of each example have been separately described, it is to be understood that functionality described with reference to one example may be suitably implemented in another example, and that certain components may be omitted depending on the implementation. It is to be understood that any feature described in relation to any one example may be used alone, or in combination with other features described, and may also be used in combination with one or more features of any other of the examples, or any combination of any other of the examples. For example, features described with respect to the system components may also be adapted to be performed as part of the described methods. Furthermore, equivalents and modifications not described above may also be employed without departing from the scope of the invention, which is defined in the accompanying claims.

1. A headset for use in construction at a construction site, the headset comprising:
an article of headwear;
a first set of sensor devices for a positioning system, the first set of sensor devices operating to track the headset at the construction site;
a second set of sensors for point measurements within the construction site using received electromagnetic signals;
a head-mounted display for displaying a virtual image of a building information model (BIM) representing the construction site; and
an electronic control system comprising at least one processor to:
track a pose of the headset within the construction site using the positioning system based on data from the first set of sensor devices, the pose of the headset being used to determine the virtual image to be displayed on the head-mounted display, the building information model being aligned with the pose using a calibrated transformation;
obtain point measurements of locations within the construction site using the second set of sensors, the point measurements comprising points within a measurement coordinate system defined by the second set of sensors, the measurement coordinate system being mapped to a positioning system coordinate system for the pose of the headset using a defined further transformation;
align the point measurements with the building information model using the calibrated transformation such that the point measurements and building information model reside within a common coordinate system; and
compare the point measurements with the building information model to determine whether the construction site matches the building information model,
wherein the point measurements are obtained iteratively and dynamically as the headset moves around the construction site.

2. The headset of claim 1, wherein the second set of sensors comprise a laser device to measure a point from the headset.

3. The headset of claim 1, wherein the at least one processor is configured to:
obtain the further transformation;
use the further transformation to map between the measurement coordinate system for the point measurements and the positioning system coordinate system to track the headset; and
use the calibrated transformation to map between the positioning system coordinate system and a coordinate system for the building information model, whereby the points and the building information model are mapped to the common coordinate system for comparison.

4. The headset of claim 1, wherein the at least one processor is configured to:
fit a surface or mesh to a plurality of points within the point measurements; and
compare the surface or mesh to at least a portion of the building information model.

5. The headset of claim 4, wherein the surface or mesh is fitted to represent one or more of a wall, a ceiling, or a door.

6. The headset of claim 4, wherein the at least one processor is configured to:
indicate to a user via the head-mounted display a match between the surface or mesh and the portion of the building information model.

7. The headset of claim 6, wherein the at least one processor is configured to:
receive an input from the user indicating an approval of an indicated match; and
responsive to the input, fix the surface or mesh as part of a set of calibration references for use in deriving the calibrated transformation.

8. The headset of claim 7, wherein the at least one processor is configured to:
identify a plurality of points within the positioning system coordinate system that are within the fixed surface or mesh;
determine an estimated location for the fixed surface or mesh;
compare the estimated location for the fixed surface or mesh with a corresponding surface or mesh within the building information model; and
use the result of the comparison to update or initialise the calibrated transformation.

9. The headset of claim 6, wherein the at least one processor is configured to:
receive an input from the user indicating an approval of an indicated mismatch; and
responsive to the input, update the portion of the building information model based on a measured position of the surface or mesh.

10. The headset of claim 1, wherein the second set of sensors comprise one or more wide-angled camera devices.

11. The headset of claim 1, wherein the second set of sensors is configured to capture data over a 360-degree field of view.

12. The headset of claim 1, wherein the second set of sensors is mounted at the top of the article of headwear.

13. A method comprising:
tracking a pose of a headset within a construction site using a positioning system based on data from a first set of sensor devices for the positioning system that are coupled to the headset, the pose of the headset being used to determine a virtual image of a building information model to be displayed on a head-mounted display coupled to the headset, the building information model being aligned with the pose using a calibrated transformation;
obtaining point measurements of locations within the construction site using a second set of sensors that are coupled to the headset, the second set of sensors operating using received electromagnetic signals, the point measurements comprising points within a measurement coordinate system defined by the second set of sensors, the measurement coordinate system being mapped to a positioning system coordinate system for the pose of the headset using a defined further transformation;
aligning the point measurements with the building information model using the calibrated transformation such that the point measurements and building information model reside within a common coordinate system; and
comparing the point measurements with the building information model to determine whether the construction site matches the building information model,
wherein the point measurements are obtained iteratively and dynamically as the headset moves around the construction site.

14. The method of claim 13, wherein the second set of sensors form part of a simultaneous mapping and localisation (SLAM) system.

15. The method of claim 13, wherein the device comprises a sensor to measure a depth of one or more locations.

16. The method of claim 13, wherein the device comprises a laser device to measure a point from the device.

17. The method of claim 13, comprising:
fitting a surface or mesh to a plurality of points within the point measurements;
comparing the surface or mesh to at least a portion of the building information model; and
indicating to a user via the head-mounted display a match or mismatch between the surface or mesh and the portion of the building information model.

18. The method of claim 17, further comprising:
receiving input from the user representing approval of the match; and
responsive to approval of the match, fixing the surface or mesh as part of a set of calibration references for use in deriving the calibrated transformation.

19. The method of claim 17, further comprising:
receiving input from the user representing approval of the mismatch; and
responsive to approval of a mismatch, updating the portion of the building information model based on a measured position of the surface or mesh.

20. A non-transitory computer-readable storage medium storing instructions which, when executed by at least one processor, cause the at least one processor to:
track a pose of a headset within a construction site using a positioning system based on data from a first set of sensor devices for the positioning system that are coupled to the headset, the pose of the headset being used to determine a virtual image of a building information model to be displayed on a head-mounted display coupled to the headset, the building information model being aligned with the pose using a calibrated transformation;
obtain point measurements of locations within the construction site using a second set of sensors that are coupled to the headset, the second set of sensors operating using received electromagnetic signals, the point measurements comprising points within a measurement coordinate system defined by the second set of sensors, the measurement coordinate system being mapped to a positioning system coordinate system for the pose of the headset using a defined further transformation;
align the point measurements with the building information model using the calibrated transformation such that the point measurements and building information model reside within a common coordinate system; and
compare the point measurements with the building information model to determine whether the construction site matches the building information model,
wherein the point measurements are obtained iteratively and dynamically as the headset moves around the construction site.
